(19) United States
(12) Patent Application Publication
(10) Pub. No.: US 2017/0098843 A1
(43) Pub. Date: Apr. 6, 2017

(54) MEMBRANELESS DIRECT LIQUID FUEL CELLS

(71) Applicant: Board of Regents, The University of Texas System, Austin, TX (US)

(72) Inventors: Arumugam Manthiram, Austin, TX (US); Xingwen Yu, San Marcos, TX (US)

(21) Appl. No.: 15/286,629

(22) Filed: Oct. 6, 2016

Related U.S. Application Data
(60) Provisional application No. 62/238,087, filed on Oct. 6, 2015.

(51) Int. Cl. H01M 8/083; H01M 4/90; H01M 4/92

(52) U.S. Cl. CPC H01M 8/083; H01M 4/926; H01M 4/9083; H01M 4/9016; H01M 4/921

(57) ABSTRACT

Disclosed herein are membraneless direct liquid fuel cells comprising an anode comprising an anode catalyst; a cathode comprising a cathode catalyst; an aqueous solution comprising a fuel, an electrolyte, and water; an oxygen source in electrochemical contact with the cathode catalyst; wherein the anode catalyst and the cathode catalyst are in electrochemical contact with the aqueous solution; wherein the anode catalyst is catalytically active for the oxidation of the fuel; wherein the cathode catalyst is catalytically active for the reduction of oxygen and is substantially catalytically inactive for the oxidation of the fuel. Also disclosed herein are catalysts that are catalytically active for the oxygen reduction reaction and/or the oxygen evolution reaction and substantially catalytically inactive for the oxidation reaction of a fuel.

### CROSS-REFERENCE TO RELATED APPLICATIONS

This application claims the benefit of U.S. Provisional Application No. 62/238,087, filed Oct. 6, 2015, which is hereby incorporated herein by reference in its entirety.

### STATEMENT OF GOVERNMENT SUPPORT

This invention was made with government support under DMR1122603 awarded by National Science Foundation. The government has certain rights in the invention.

### BACKGROUND

The oxygen electrochemistry including both the oxygen reduction reaction (ORR) and the oxygen evolution reaction (OER) is of focus currently for a variety of renewable energy storage/generation applications, such as metal-air batteries and fuel cells (Suntivich J et al. Science, 2011, 334, 1383-1385; Suntivich J et al. Nat. Chem., 2011, 3, 546-550). Platinum-based materials are catalysts for the oxygen reduction reaction in both acidic and alkaline media, but their application is hampered by the limited abundance and high cost of Pt (Stamenkovic V et al. Angew. Chem. Int. Edit., 2006, 45, 2897-2901; Srivastava R et al. Angew. Chem. Int. Edit., 2007, 46, 8988-8991; Morozan A et al. Energy Environ. Sci., 2011, 4, 1238-1254).

Among the various types of fuel cells, proton exchange membrane fuel cells (PEMFCs) are in the forefront owing to their advantageous features, such as being operable at low temperatures. H₂-fed proton exchange membrane fuel cells and proton exchange membrane (PEM) based direct liquid fuel cells (DLFCs) are the dominant options for power sources for portable, automobile, and stationary applications (Wang Y et al. Appl. Energy, 2011, 88, 981-1007: Chen Z W et al. Energy Environ. Sci., 2011, 4, 3167-3192; Sharma S and Pollet B G. J. Power Sources, 2012, 208, 96-119). In comparison to the H₂-proton exchange membrane fuel cells, liquid-fed fuel cells can possess certain advantages in terms of fuel storage, transportation, safety, and simple cell configuration. Among the proton exchange membrane based direct liquid fuel cells, the direct methanol fuel cells (DMFCs), direct ethanol fuel cells (DEFCs), and direct formic acid fuel cells (DFAFCs) have attracted particular attention (Zhao X et al. Energy Environ. Sci., 2011, 4, 2736-2753; Li X L and Faghri A. J. Power Sources, 2013, 226, 223-240; Kamarudin M Z F et al. Int. J. Hydrogen Energ., 2013, 38, 9438-9453; Ji X L et al. Nat. Chem., 2010, 2, 286-293; Yu X W and Pickup P G. J Power Sources, 2008, 182, 124-132). However, despite many years of intensive research into these direct liquid fuel cell technologies, limitations still remain.

### SUMMARY

Disclosed herein are membraneless direct liquid fuel cells. The membraneless direct liquid fuel cell 100 can comprise an anode 102 comprising an anode catalyst 104 in electrochemical contact with an aqueous solution 110. The aqueous solution 110 can comprise a fuel, an electrolyte, and water. In some examples, the fuel can comprise an organic liquid (e.g., alcohols, polyols). In some examples, the fuel can be selected from the group consisting of methanol, ethanol, ethylene glycol, and glycerol. In some examples, the fuel comprises formate. In some examples, the pH of the aqueous solution 110 is greater than 7.

The anode catalyst 104 is catalytically active for the oxidation of the fuel. In some examples, the anode catalyst 104 can comprise a precious metal, a non-precious metal, or combinations thereof. The precious metal can, for example, be selected from the group consisting of Pd, Ag, Pt, Au, and combinations thereof. In some examples, the anode catalyst 104 comprises Pd. In some examples, the anode catalyst 104 can comprise Pd/C, PdCu/C, PdPb/C, PdBi/C, PdSb/C, PtRu/C. PtPb/C, PtBi/C, PtSn/C, Ni, or combinations thereof.

In some examples, the current density for the oxidation of the fuel on the anode catalyst 104 can be from 0 mA cm⁻² to 1000 mA cm⁻² in the potential range of −0.7 to 0.1 V as measured against a standard hydrogen electrode (SHE). In some examples, the current density for the oxidation of the fuel on the anode catalyst 104 can be 20 mA cm⁻² or more in the potential range of −0.7 to 0.1 V as measured against a standard hydrogen electrode (SHE).

In some examples, the rate of oxidation of the fuel on the anode catalyst 104 is substantially stable (e.g., the current density decays 0.2% or less after 100 hours of operation).

In some examples, the loading of the anode catalyst 104 on the anode 102 (e.g., the weight of anode catalyst 104 per unit area of the anode 102) is from 0.5 mg cm⁻² to 10 mg cm². In some examples, the loading of the anode catalyst 104 on the anode 102 is 1.0 mg cm⁻² or more.

In some examples, the membraneless direct liquid fuel cell 100 can further comprise a cathode 106 comprising a cathode catalyst 108 in electrochemical contact with the aqueous solution 110. In some examples, the membraneless direct liquid fuel cell 100 can further comprise an oxygen source 112 in electrochemical contact with the cathode catalyst 108. In some examples, the oxygen source 112 can comprise air, oxygen, a peroxide, or a combination thereof.

The cathode catalyst 108 is catalytically active for the reduction of oxygen and is substantially catalytically inactive for the oxidation of the fuel. In some examples, the cathode catalyst 108 can comprise a noble metal, a metal oxide, a carbon-based catalyst, or combinations thereof. The noble metal can, for example, be selected from the group consisting of Ru, Rh, Pd, Ag, Os. Ir, Pt, Au, and combinations thereof. The metal oxide can, for example, comprise a metal selected from the group consisting of Ti, V, Cr, Mn, Fe, Co, Ni, Cu, Zr, Nb, Mo, Tc, Ru, Rh, Pd, Ag, Hf, Ta, W, Re, Os, Ir, Pt, Au, La, Ce, Pr, Nd, Pm, Sm, Eu, Gd, Tb, Dy, Ho, Er, Tm, Yb, and combinations thereof. In some examples, the metal oxide can comprise a binary metal oxide (e.g., a metal oxide comprising two metals). In some examples, the metal oxide can comprise a manganese-cobalt oxide (e.g., MnCo₂O₄). In some examples, the metal oxide can comprise a nickel-cobalt oxide (e.g., NiCo₂O₄). In some examples, the metal oxide can comprise a ternary metal oxide (e.g., a metal oxide comprising three metals). In some examples, the metal oxide can comprise a manganese-nickel-cobalt oxide (e.g., MnNiCoO₄). In some examples, the metal oxide can comprise a quaternary metal oxide (e.g., a metal oxide comprising four metals).

In some examples, the cathode catalyst 108 can comprise a plurality of particles comprising the metal oxide deposited on a carbon material. In certain examples, the cathode catalyst 108 can comprises from 10 to 80 percent by weight of the plurality of metal oxide particles. In some examples, the cathode catalyst 108 can comprise from 20 wt. % to 80 wt. % of the plurality of metal oxide particles. In some examples, the cathode catalyst 108 can comprise from 40 wt. % to 45 wt. % of the plurality of metal oxide particles.

In some examples, the plurality of metal oxide particles have an average maximum dimension (e.g., an average maximum dimension for spheroidal particles) of from 2 nm to 50 nm.

In some examples, the carbon material can comprise a plurality of carbon nanotubes. The carbon nanotubes can, for example, comprise multi-walled carbon nanotubes (MWCNT). In some examples, the carbon nanotubes can comprise nitrogen doped carbon nanotubes (N-CNT).

In some examples, the carbon nanotubes can comprise nitrogen doped multi-walled carbon nanotubes (N-MWCNT). The carbon nanotubes can, for example, have a diameter of from 10 nm to 100 nm. In some examples, the carbon nanotubes can have a length of from 3 μm to 200 μm. In some examples, the carbon nanotubes have an aspect ratio (e.g., the ratio of length:diameter) of from 10 to 200.

In some examples, the carbon material can comprise graphene. In some examples, the carbon material can comprise nitrogen-doped graphene (N-graphene).

In some examples, the cathode catalyst 108 can comprises Pt, MnCo₂O₄/N-MWCNT (e.g., a plurality of MnCo₂O₄ particles deposited on a plurality of nitrogen doped multi-walled carbon nanotubes), MnNiCoO₄/N-MWCNT, NiCo₂O₄/N-graphene, or combinations thereof.

In some examples, the current density for the oxidation of the fuel on the cathode catalyst 108 can be from 0 mA cm⁻² to 10 mA cm⁻² in the potential range of −0.7 to 0.1 V as measured against a standard hydrogen electrode (SHE). In some examples, the current density for the oxidation of the fuel on the cathode catalyst 108 can be 1 mA cm⁻² or less in the potential range of −0.7 to 0.1 V as measured against a standard hydrogen electrode (SHE).

In some examples, the oxygen reduction reaction onset potential on the cathode catalyst 108 can be from 0.9 V to 1.0 V as measured against a reversible hydrogen electrode (RHE). In some examples, the oxygen reduction reaction onset potential on the cathode catalyst 108 can be 0.97 V or less as measured against a reversible hydrogen electrode (RHE). In some examples, the oxygen reduction reaction onset potential on the cathode catalyst 108 can be from 0.94 V to 0.97 V as measured against a reversible hydrogen electrode (RHE).

In some examples, the oxygen reduction reaction peak potential on the cathode catalyst 108 can be from 0.85 V to 0.95 V as measured against a reversible hydrogen electrode (RHE). In some examples, the oxygen reduction reaction peak potential on the cathode catalyst 108 can be 0.90 V or less as measured against a reversible hydrogen electrode (RHE). In some examples, the oxygen reduction reaction peak potential on the cathode catalyst 108 can be from 0.87 V to 0.90 V as measured against a reversible hydrogen electrode (RHE).

In some examples, the loading of the cathode catalyst 108 on the cathode 106 (e.g., the weight of cathode catalyst 108 per unit area of the cathode 106) can be from 0.5 mg cm⁻² to 10 mg cm⁻². In some examples, the loading of the cathode catalyst 108 on the cathode 106 can be 0.5 mg cm⁻² or more (e.g., 1.0 mg cm⁻² or more).

In some examples, the loading of the anode catalyst 104 on the anode 102 is substantially the same as the loading of the cathode catalyst 108 on the cathode 106.

In some examples, the open circuit voltage of the membraneless direct liquid fuel cell 100 can be from 0.7 V to 1.2 V. In some examples, the open circuit voltage of the membraneless direct liquid fuel cell 100 can be 1.05 V or more.

In some examples, the specific power of the membraneless direct liquid fuel cell 100 can be from 40 mW cm⁻² to 400 mW cm⁻². In some examples, the specific power of the membraneless direct liquid fuel cell 100 can be 75 mW per mg of anode catalyst 104 at 60° C. In some examples, the specific power of the membraneless direct liquid fuel cell 100 is 90 mW cm⁻² at 50° C.

In some examples, the specific current of the membraneless direct liquid fuel cell 100 can be from 10 mA cm⁻² to 1000 mA cm⁻². In some examples, the specific current of membraneless direct liquid fuel cell 100 can be from 100 mA to 500 mA per mg of anode catalyst 104 (me of net catalyst, not including the supportive carbon materials) at 0.6 V and 60° C. In some examples, the specific current of the membraneless direct liquid fuel cell 100 can be 120 mA cm⁻² at 0.6 V and 50° C.

Disclosed herein are catalysts that are catalytically active for the oxygen reduction reaction and/or the oxygen evolution reaction and substantially catalytically inactive for the oxidation reaction of a fuel.

The catalysts can comprise a plurality of particles comprising a metal oxide deposited on a carbon material. In some examples, the metal oxide can comprises a metal selected from the group consisting of Ti, V, Cr, Mn, Fe, Co, Ni, Cu, Zr, Nb, Mo, Tc, Ru, Rh, Pd, Ag, Hf, Ta, W, Re, Os, Ir, Pt, Au, La, Ce, Pr, Nd, Pm, Sm, Eu, Gd, Tb, Dy, Ho, Er, Tm, Yb, and combinations thereof. In some examples, the metal oxide can comprise a binary metal oxide (e.g., a metal oxide comprising two metals). In some examples, the metal oxide can comprise a manganese-cobalt oxide, such as MnCo₂O₄. In some examples, the metal oxide can comprise a nickel-cobalt oxide (e.g., NiCo₂O₄). In some examples, the metal oxide can comprise a ternary metal oxide. In some examples, the metal oxide can comprise a quaternary metal oxide. In some examples, the metal oxide can comprise a manganese-nickel-cobalt oxide, such as MnNiCoO₄.

In some examples, the catalyst can comprise from 10 to 80 percent by weight of the plurality of metal oxide particles. In some examples, the cathode catalyst 108 can comprise from 20 wt. % to 80 wt. % of the plurality of metal oxide particles. In some examples, the catalyst can comprise from 40 wt. % to 45 wt. % of the plurality of metal oxide particles.

In some examples, the plurality of metal oxide particles can have an average maximum dimension (e.g., an average diameter for spheroidal particles) of from 2 nm to 50 nm.

In some examples, the carbon material can comprise a plurality of carbon nanotubes. In some examples, the carbon nanotubes can comprise multi-walled carbon nanotubes (MWCNT). In some examples, the carbon nanotubes can comprise nitrogen doped carbon nanotubes (N-CNT). In some examples, the carbon nanotubes can comprise nitrogen doped multi-walled carbon nanotubes (N-MWCNT). In some examples, the carbon nanotubes can have a diameter of from 10 nm to 100 nm. In some examples, the carbon nanotubes can have a length of from 3 μm to 200 μm. In some examples, the carbon nanotubes have an aspect ratio (e.g., ratio of length:diameter) of from 10 to 200.

In some examples, the carbon material can comprise graphene. In some examples, the carbon material can comprise nitrogen doped graphene (N-graphene).

In some examples, the catalyst can comprise MnCo₂O₄/N-MWCNT (e.g., a plurality of MnCo₂O₄ particles deposited on nitrogen doped multi-walled carbon nanotubes), MnNiCoO₄/N-MWCNT, NiCo₂O₄/N-graphene, or combinations thereof.

Also described herein are methods of making the catalysts described herein. In some examples, the catalysts can be synthesized using an impregnation-hydrothermal process.

Also provided herein are methods of use of the catalysts described herein. In some examples, the catalysts described herein can be used on an electrode. In other words, also disclosed herein are electrodes comprising the catalysts described herein. The loading of the catalyst on the electrode (e.g., the weight of catalyst per unit area of the electrode) can be from 0.5 mg cm⁻² to 10 mg cm⁻². In some examples, the loading of the catalyst on the electrode is 1.0 mg cm⁻² or more.

In some examples of the electrodes described herein, the current density for the oxidation of a fuel on the catalyst can be from 0 mA cm⁻² to 10 mA cm⁻² in the potential range of −0.7 to 0.1 V as measured against a standard hydrogen electrode (SHE). In some examples, the current density for the oxidation of a fuel on the catalyst can be 1 mA cm⁻² or less in the potential range of −0.7 to 0.1 V as measured against a standard hydrogen electrode (SHE).

In some examples of the electrodes described herein, the oxygen reduction reaction onset potential on the catalyst can be from 0.9 V to 1.0 V as measured against a reversible hydrogen electrode (RHE). In some examples of the electrodes described herein, the oxygen reduction reaction onset potential on the catalyst is 0.97 V or less as measured against a reversible hydrogen electrode (RHE). In some examples of the electrodes described herein, the oxygen reduction reaction onset potential on the catalyst can be from 0.94 V to 0.97 V as measured against a reversible hydrogen electrode (RHE).

In some examples of the electrodes described herein, the oxygen reduction reaction peak potential on the catalyst can be from 0.85 V to 0.95 V as measured against a reversible hydrogen electrode (RHE). In some examples of the electrodes described herein, the oxygen reduction reaction peak potential on the catalyst can be 0.90 V or less as measured against a reversible hydrogen electrode (RHE). In some examples of the electrodes described herein, the oxygen reduction reaction peak potential on the catalyst can be from 0.87 V to 0.90 V as measured against a reversible hydrogen electrode (RHE).

In some examples, the electrodes described herein can be used as a cathode in a battery (e.g., a rechargeable metal-air battery).

In some examples, the electrodes described herein can be used as a cathode in a fuel cell. In some examples, the electrodes described herein can be used as a cathode in a membraneless direct liquid fuel cell, such as a membraneless direct liquid fuel cell.

The details of one or more embodiments of the invention are set forth in the accompanying drawings and the description below. Other features, objects, and advantages of the invention will be apparent from the description and drawings, and from the claims.

### DESCRIPTION OF FIGURES

FIG. 1 displays a schematic representation of a membraneless alkaline direct liquid fuel cell.

FIG. 2 displays the cyclic voltammograms of Pd/C and Pt/C electrodes in an electrolyte containing 1.0 M HCOOK in 1.0 M KOH at 20 mV s⁻¹ at ambient temperature.

FIG. 3 displays a schematic representation of a membraneless alkaline direct formate fuel cell (DFFC) and the selective oxidation of formate on the catalysts.

FIG. 4 displays the polarization curved of the membraneless alkaline direct formate fuel cell operated at various temperatures.

FIG. 5 displays the power plots of the membraneless alkaline direct formate fuel cell operated at various temperatures.

FIG. 6 displays the linear sweep voltammograms of Pd/C, PtRu/C, and Pt/C electrodes in various alkaline electrolytes (1.0 M HCOOK+1.0 M KOH, 1.0 M HCOONa+1.0 M NaOH, 1.0 M CH₃OH+1.0 M KOH and 1.0 M CH₃CH₂OH+1.0 M KOH) at a scan rate of 20 mV s⁻¹ and at ambient temperature.

FIG. 7 displays the linear sweep voltammograms of Pd/C, PtRu/C, and Pt/C electrodes in an acidic electrolyte (1.0 M HCOOH+1.0 M H₂SO₄) at a scan rate of 20 mV s⁻¹ and at ambient temperature.

FIG. 8 displays a comparison of the oxidation kinetics between formates (in alkaline medium) and formic acid (in acidic media) via linear sweep voltammograms plotted by subtracting the oxidation potentials from the standard oxygen reduction potentials in different media (0.40 V in alkaline medium, 1.23 V in acidic medium) for a Pd/C electrode in various electrolytes (1.0 M HCOOK+1.0 M KOH, 1.0 M HCOONa+1.0 M NaOH, and 1.0 M HCOOH+1.0 M H₂SO₄). Experiments were performed at fixed potentials of −0.25 V (vs. SHE) for the formate fuels and 0.58 V (vs. SHE) for the formic acid fuel, which correspond to an identical 0.65 V fuel cell operation voltage in all cases (standard oxygen reduction potentials are 0.40 V in alkaline media and 1.23 V in acidic media). The experiments were performed at ambient temperature.

FIG. 9 displays a comparison of the oxidation kinetics between formates (in alkaline medium) and formic acid (in acidic media) via current vs. time curves for a Pd/C electrode in various electrolytes (1.0 M HCOOK+1.0 M KOH, 1.0 M HCOONa+1.0 M NaOH, and 1.0 M HCOOH+1.0 M H₂SO₄). Experiments were performed at fixed potentials of −0.25 V (vs. SHE) for the formate fuels and 0.58 V (vs. SHE) for the formic acid fuel, which correspond to an identical 0.65 V fuel cell operation voltage in all cases (standard oxygen reduction potentials are 0.40 V in alkaline media and 1.23 V in acidic media). The experiments were performed at ambient temperature.

FIG. 10 displays a scanning transmission electron microscope (STEM) image of the MnNiCoO₄/N-MWCNT catalyst.

FIG. 11 displays the energy dispersive x-ray spectroscopy (EDS) spectrum of the MnNiCoO₄/N-MWCNT catalyst.

FIG. 12 displays the X-ray powder diffraction (XRD) patterns of the MnNiCoO₄/N-MWCNT catalyst, MnCo₂O₄/N-MWCNT catalyst, and N-MWCNT.

FIG. 13 displays the Raman spectra of the MnNiCoO₄/N-MWCNT catalyst. MnCo₂O₄/N-MWCNT catalyst, and pristine MWCNT.

FIG. 14 displays the cyclic voltammetry (CV) profiles of the Pt/C, MnNiCoO₄/N-MWCNT, and MnCo₂O₄/N-MWCNT catalysts on glassy carbon electrodes in O₂-saturated 1 M KOH.

FIG. 15 displays the rotating-disk electrode (RDE) voltammograms of the MnNiCoO₄/N-MWCNT catalyst in O₂-saturated 1 M KOH with a sweep rate of 5 mV s⁻¹ at various rpm.

FIG. 16 displays the rotating-disk electrode (RDE) voltammograms of the MnCo₂O₄/N-MWCNT catalyst in O₂-saturated 1 M KOH with a sweep rate of 5 mV s⁻¹ at various rpm.

FIG. 17 displays the rotating-disk electrode (RDE) voltammograms of the Pt/C catalyst in O₂-saturated 1 M KOH with a sweep rate of 5 mV s⁻¹ at various rpm.

FIG. 18 displays the rotating-disk electrode voltammograms of Pt/C, MnNiCoO₄/N-MWCNT, and MnCo₂O₄/N-MWCNT catalysts in O₂-saturated 1 M KOH at a scan rate of 5 mV s⁻¹ at 1600 rpm.

FIG. 19 displays the rotating ring-disk electrode voltammograms of the MnNiCoO₄/N-MWCNT and MnCo₂O₄/N-MWCNT catalysts in O₂-saturated 1 M KOH at 1600 rpm. The disk potential was scanned at 5 mV s⁻¹ and the ring potential was constant at 1.3 V vs. reversible hydrogen electrode. Inset shows the magnified ring currents.

FIG. 20 displays the rotating ring-disk electrode (RRDE) voltammograms of the Pt/C catalyst in O₂-saturated 1 M KOH at 1600 rpm. The disk potential was scanned at 5 mV s⁻¹ and the ring potential was constant at 1.3 V vs. reversible hydrogen electrode (RHE).

FIG. 21 displays the electron transfer number n of the MnNiCoO₄/N-MWCNT and MnCo₂O₄/N-MWCNT catalysts at various potentials based on the corresponding rotating ring-disc electrode results.

FIG. 22 displays the percentage of peroxide with respect to the total oxygen reduction products of the MnNiCoO₄/N-MWCNT and MnCo₂O₄/N-MWCNT catalysts at various potentials based on the corresponding rotating ring-disc electrode results.

FIG. 23 displays the electron transfer number n of the Pt/C catalyst at various potentials based on the corresponding rotating ring-disk electrode results.

FIG. 24 displays the percentage of peroxide with respect to the total oxygen reduction products of the Pt/C catalyst at various potentials based on the corresponding RRDE results.

FIG. 25 displays Koutecky-Levich plots for the oxygen reduction reaction in O₂-saturated 1.0 M KOH on the MnNiCoO₄/N-MWCNT, MnCo₂O₄/N-MWCNT, and Pt/C catalysts. The data were derived from the rotating-disk electrode experiments shown in FIGS. 14-16.

FIG. 26 displays the Oxygen reduction polarization curves of the Pt/C. MnNiCoO₄/N-MWCNT, and MnCo₂O₄/N-MWCNT catalysts loaded onto carbon-fiber papers in 1 M KOH electrolyte saturated with oxygen.

FIG. 27 displays the oxygen evolution currents of Pt/C, MnNiCoO₄/N-MWCNT, and MnCo₂O₄/N-MWCNT catalysts loaded onto carbon-fiber paper in 1 M KOH electrolyte.

FIG. 28 displays the cyclic voltammograms of the MnNiCoO₄/N-MWCNT, Pt/C, and Pd/C electrodes in an electrolyte containing 1.0 M HCOOK in 1.0 M KOH at 10 mV s⁻¹. Experiments were performed at ambient temperature.

FIG. 29 displays the polarization curves of the membraneless alkaline direct formate fuel cells (DFFCs) with Pd/C as the anode catalyst and with MnNiCoO₄N-MWCNT or Pt/C as cathode catalysts. The cells were operated at 25° C. and 50° C.

FIG. 30 displays the power plots of the membraneless alkaline direct formate fuel cells (DFFCs) with Pd/C as the anode catalyst and with MnNiCoO₄N-MWCNT or Pt/C as cathode catalysts. The cells were operated at 25° C. and 50° C.

FIG. 31 displays a schematic of a membraneless alkaline direct liquid fuel cell based on a laminar-flow management.

FIG. 32 displays a schematic of a membraneless alkaline direct liquid fuel cell based on a catalyst-selective strategy.

FIG. 33 displays a scanning transmission electron microscope (STEM) image of the NiCo₂O₄/N-graphene catalyst.

FIG. 34 displays the energy dispersive x-ray spectroscopy (EDS) spectrum of the NiCo₂O₄/N-graphene catalyst.

FIG. 35 displays the X-ray powder diffraction (XRD) patterns of the NiCo₂O₄/N-graphene catalyst and graphene.

FIG. 36 displays the cyclic voltammetry profiles of the Pt/C and the NiCo₂O₄/N-graphene catalysts on glassy carbon electrodes in O₂-saturated 1.0 M KOH.

FIG. 37 displays the rotating-disk electrode (RDE) voltammograms of the NiCo₂O₄/N-graphene catalyst in O₂-saturated 1 M KOH with a sweep rate of 5 mV/s at various rpm.

FIG. 38 displays the rotating-disk electrode voltammograms of Pt/C and NiCo₂O₄/N-graphene catalysts in O₂-saturated 1.0 M KOH at a scan rate of 5 mV s⁻¹ at 1600 rpm.

FIG. 39 displays the rotating ring disk electrode (RRDE) voltammograms of the NiCo₂O₄/N-graphene catalyst in O₂-saturated 1 M KOH at 1600 rpm. The disk potential was scanned at 5 mV s⁻¹ and the ring potential was constant at 1.3 V vs. RHE.

FIG. 40 displays the electron-transfer number (n) of the NiCo₂O₄IN-graphene catalyst at various potentials based on the corresponding rotating ring-disk electrode results.

FIG. 41 displays the percentage of peroxide with respect to the total oxygen reduction products of the NiCo₂O₄/N-graphene catalyst at various potentials based on the corresponding rotating ring-disk electrode results.

FIG. 42 displays the cyclic voltammograms (10 mV s⁻¹) of the MnNiCoO₄/N-MWCNT and PtRu/C electrodes in the electrolyte containing either 1.0 M CH₃OH in 1.0 M KOH or 1.0 M CH₃CH₂OH in 1.0 M KOH.

FIG. 43 displays cyclic voltammograms (10 mV s⁻¹) of NiCo₂O₄/N-graphene and PtRu/C electrodes in the electrolyte containing either 1.0 M ethylene glycol (EG) in 1.0 M KOH or 1.0 M glycerol (G) in 1.0 M KOH.

FIG. 44 displays a schematic of a membraneless alkaline direct liquid fuel cell (DLFC) and the selective oxidation of fuel on the catalysts.

FIG. 45 displays the polarization curves and corresponding power plots of the direct methanol fuel cell (DMFC) operated at different temperatures.

FIG. 46 displays the polarization curves and corresponding power plots of the direct ethanol fuel cell (DEFC) operated at different temperatures.

FIG. 47 displays the polarization curves and corresponding power plots of the direct ethylene glycol fuel cell (DEGFC) operated at different temperatures.

FIG. 48 displays the polarization curves and corresponding power plots of the direct glycerol fuel cell (DGFC) operated at different temperatures.

### DETAILED DESCRIPTION

The compounds, compositions, devices, and methods described herein may be understood more readily by reference to the following detailed description of specific aspects of the disclosed subject matter and the Examples included therein.

Before the present compounds, compositions, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### GENERAL DEFINITIONS

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a.” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Catalysts

Disclosed herein are catalysts that are catalytically active for the oxygen reduction reaction and/or the oxygen evolution reaction and substantially catalytically inactive for the oxidation reaction of a fuel. In some examples, the fuel can comprise an organic liquid (e.g., alcohols, polyols). In some examples, the fuel can be selected from the group consisting of methanol, ethanol, ethylene glycol, and glycerol. In some examples, the fuel comprises formate.

The catalysts can comprise a plurality of particles comprising a metal oxide deposited on a carbon material. In some examples, the metal oxide can comprises a metal selected from the group consisting of Ti, V, Cr, Mn, Fe, Co, Ni, Cu, Zr, Nb, Mo, Tc, Ru, Rh, Pd, Ag, Hf, Ta, W, Re, Os, Ir, Pt, Au, La, Ce, Pr, Nd, Pm, Sm, Eu, Gd, Tb, Dy, Ho, Er, Tm, Yb, and combinations thereof. In some examples, the metal oxide can comprise a binary metal oxide (e.g., a metal oxide comprising two metals). In some examples, the metal oxide can comprise a manganese-cobalt oxide, such as MnCo₂O₄. In some examples, the metal oxide can comprise a nickel-cobalt oxide (e.g., NiCo₂O₄). In some examples, the metal oxide can comprise a ternary metal oxide (e.g., a metal oxide comprising three metals). In some examples, the metal oxide can comprise a quaternary metal oxide (e.g., a metal oxide comprising four metals). In some examples, the metal oxide can comprise a manganese-nickel-cobalt oxide, such as MnNiCoO₄.

In some examples, the catalyst can comprise 10 percent by weight (wt. %) or more of the plurality of metal oxide particles (e.g., 15 wt. % or more, 20 wt. % or more, 25 wt. % or more, 30 wt. % or more, 35 wt. % or more, 40 wt. % or more, 45 wt. % or more, 50 wt. % or more, 55 wt. % or more, 60 wt. % or more, 65 wt. % or more, 70 wt. % or more, or 75 wt. % or more). In some examples, the catalyst can comprise 80 wt. % or less of the plurality of metal oxide particles (e.g., 75 wt. % or less, 70 wt. % or less, 65 wt. % or less, 60 wt. % or less, 55 wt. % or less, 50 wt. % or less, 45 wt. % or less, 40 wt. % or less, 35 wt. % or less, 30 wt. % or less, 25 wt. % or less, 20 wt. % or less, or 15 wt. % or less). The percent by weight of the plurality of metal oxide particles of the catalyst can range from any of the minimum values described above to any of the maximum values described above. In some examples, the catalyst can comprise from 10 to 80 percent by weight of the plurality of metal oxide particles (e.g., from 10 wt. % to 45 wt. %, from 45 wt. % to 80 wt. %, from 10 wt. % to 20 wt. %, from 20 wt. % to 30 wt. %, from 30 wt. % to 40 wt. %, from 40 wt. % to 50 wt. %, from 50 wt. % to 60 wt. %, from 60 wt. % to 70 wt. %, from 70 wt. % to 80 wt. %, from 20 wt. % to 80 wt. %, from 20 wt. % to 70 wt. %, from 30 wt. % to 60 wt. %, or from 35 wt. % to 55 wt. %).

In some examples, the catalyst can comprise 40 percent by weight (wt. %) of the plurality of metal oxide particles or more (e.g., 40.5 wt. % or more, 41 wt. % or more, 41.5 wt. % or more, 42 wt. % or more, 42.5 wt. % or more, 43 wt. % or more, 43.5 wt. % or more, 44 wt. % or more, or 44.5 wt. % or more). In some examples, the catalyst can comprise 45 wt. % of the plurality of metal oxide particles or less (e.g., 44.5 wt. % or less, 44 wt. % or less, 43.5 wt. % or less, 43 wt. % or less, 42.5 wt. % or less, 42 wt. % or less, 41.5 wt. %6 or less, 41 wt. % or less, or 40.5 wt. % or less). The percent by weight of the plurality of metal oxide particles of the catalyst can range from any of the minimum values described above to any of the maximum values described above. In some examples, the catalyst can comprise from 40 wt. % to 45 wt. % of the plurality of metal oxide particles (e.g., from 40 wt. % to 42.5 wt. %, from 42.5 wt. % to 45 wt. %, from 40 wt. % to 41 wt. %, from 41 wt. % to 42 wt. %, from 42 wt. % to 43 wt. %, from 43 wt. % to 44 wt. %, from 44 wt. % to 45 wt. %, or from 41 wt. % to 44 wt. %).

The plurality of metal oxide particles can, for example, have an average maximum dimension (e.g., an average diameter for spheroidal particles) of 2 nm or more (e.g., 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, or 45 nm or more). In some examples, the plurality of metal oxide particles can have an average maximum dimension (e.g., an average diameter for spheroidal particles) of 50 nm or less (e.g., 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, 5 nm or less, 4 nm or less, or 3 nm or less). The average maximum dimension of the plurality of metal oxide particles can range from any of the minimum values described above to any of the maximum values described above. In some examples, the plurality of metal oxide particles can have an average maximum dimension (e.g., an average diameter for spheroidal particles) of from 2 nm to 50 nm (e.g., from 2 nm to 25 nm, from 25 nm to 50 nm, from 2 nm to 10 nm, from 10 nm to 20 nm, from 20 nm to 30 nm, from 30 nm to 40 nm, from 40 nm to 50 nm, or from 5 nm to 45 nm).

As used herein “carbon materials” is meant to refer to materials comprising carbon. Examples of carbon materials include, for example, graphene, activated carbon, carbon black, amorphous carbon, graphite, carbon nanotubes, and combinations thereof.

In some examples, the carbon material can comprise a plurality of carbon nanotubes. Carbon nanotubes have been studied intensively since their discovery in 1991. Nanotubes are found in single sheet wall or multi-wall forms in a wide range of diameters and lengths. In some examples, the carbon nanotubes can comprise multi-walled carbon nanotubes (MWCNT). In some examples, the carbon nanotubes can comprise nitrogen doped carbon nanotubes (N-CNT). In some examples, the carbon nanotubes can comprise nitrogen doped multi-walled carbon nanotubes (N-MWCNT).

In some examples, the carbon nanotubes can have a diameter of 10 nm or more (e.g., 15 nm or more, 20 nm or more, 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, 90 nm or more, or 95 nm or more). In some examples, the carbon nanotubes can have a diameter of 100 nm or less (e.g., 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, or 15 nm or less). The diameter of the carbon nanotubes can range from any of the minimum values above to any of the maximum values above. In some examples, the carbon nanotubes can have a diameter of from 10 nm to 100 nm (e.g., from 10 nm to 55 nm, from 55 nm to 100 nm, from 10 nm to 25 nm, from 25 nm to 40 nm, from 40 nm to 55 nm, from 55 nm to 70 nm, from 70 nm to 85 nm, from 85 nm to 100 nm, 20 nm to 90 nm, or from 30 nm to 80 nm).

The carbon nanotubes can have a length, for example, of 3 μm or more (e.g., 5 μm or more, 10 μm or more, 15 μm or more, 20 μm or more, 25 μm or more, 30 μm or more, 35 μm or more, 40 μm or more, 45 μm or more, 50 μm or more, 60 μm or more, 70 μm or more, 80 μm or more, 90 μm or more, 100 μm or more, 110 μm or more, 120 μm or more, 130 μm or more, 140 μm or more, 150 μm or more, 160 μm or more, 170 μm or more, 180 μm or more, or 190 μm or more). In some examples, the carbon nanotubes can have a length of 200 μm or less (e.g., 190 μm or less, 180 μm or less, 170 μm or less, 160 μm or less, 150 μm or less, 140 μm or less, 130 μm or less, 120 μm or less, 110 μm or less, 100 μm or less, 90 μm or less, 80 μm or less, 70 μm or less, 60 μm or less, 50 μm or less, 45 μm or less, 40 μm or less, 35 μm or less, 30 μm or less, 25 μm or less, 20 μm or less, 15 μm or less, 10 μm or less, or 5 μm or less). The length of the carbon nanotubes can range from any of the minimum values described above to any of the maximum values described above. In some examples, the carbon nanotubes can have a length of from 3 μm to 200 μm (e.g., from 3 μm to 100 μm, from 100 μm to 200 μm, from 3 μm to 50 μm, from 50 μm to 100 μm, from 100 μm to 150 μm, from 150 μm to 200 μm, from 5 μm to 190 μm, or from 10 μm to 150 μm).

In some examples, the carbon nanotubes have an aspect ratio (e.g., length divided by diameter) of 10 or more (e.g., 15 or more, 20 or more, 25 or more, 30 or more, 35 or more, 40 or more, 45 or more, 50 or more, 60 or more, 70 or more, 80 or more, 90 or more, 100 or more, 110 or more, 120 or more, 130 or more, 140 or more, 150 or more, 160 or more, 170 or more, 180 or more, or 190 or more). In some examples, the carbon nanotubes can have an aspect ratio of 200 or less (e.g., 190 or less, 180 or less, 170 or less, 160 or less, 150 or less, 140 or less, 130 or less, 120 or less, 110 or less, 100 or less, 90 or less, 80 or less, 70 or less, 60 or less, 50 or less, 45 or less, 40 or less, 35 or less, 30 or less, 25 or less, 20 or less, or 15 or less). The aspect ratio of the carbon nanotubes can range from any of the minimum values described above to any of the maximum values described above. In some examples, the carbon nanotubes can have an aspect ratio of from 10 to 200 (e.g., from 10 to 100, from 100 to 200, from 10 to 50, from 50 to 100, from 100 to 150, from 150 to 200, or from 20 to 190).

In some examples, the carbon material can comprise graphene. The term “graphene,” as used herein, refers to materials that include from one to several atomic monolayers of sp²-bonded carbon atoms. The term “graphene,” as used herein can thus include a wide range of graphene-based materials including, for example, graphene oxide, chemically converted graphene, functionalized graphene, functionalized graphene oxide, functionalized chemically converted graphene, and combinations thereof. In some examples, the carbon material can comprise nitrogen doped graphene (N-graphene).

In some examples, the catalyst can comprise MnCo₂O₄/N-MWCNT (e.g., a plurality of MnCo₂O₄ particles deposited on nitrogen doped multi-walled carbon nanotubes), MnNiCoO₄/N-MWCNT. NiCo₂O₄/N-graphene, or combinations thereof.

Methods of Making

Also described herein are methods of making the catalysts described herein. In some examples, the catalysts can be synthesized using an impregnation-hydrothermal process. For example, the method can comprise refluxing a powder comprising the carbon material in an acid (e.g., nitric acid). The method can further comprise cooling the mixture to room temperature and diluting the cooled mixture with water. The method can further comprise collecting the resulting solid (e.g., by centrifugation), washing the collected solid with water, and drying the washed solid (e.g., under vacuum). After drying, the method can further comprise adding selected amounts of solutions comprising the metal oxide precursors to the dried solid, followed by the addition of nitrogen-containing nucleation species. The method can, for example, further comprises heating and/or agitating the mixture. In some examples, the method can further comprise performing a hydrothermal reaction, for example, by heating the mixture, thereby obtaining the catalyst.

Methods of Use

Also provided herein are methods of use of the catalysts described herein. In some examples, the catalysts described herein can be used on an electrode. In other words, also disclosed herein are electrodes comprising the catalysts described herein. The loading of the catalyst on the electrode (e.g., the weight of catalyst per unit area of the electrode) can be, for example, 0.5 mg cm⁻² or more (e.g., 0.6 mg cm⁻² or more, 0.7 mg cm⁻² or more, 0.8 mg cm⁻² or more, 0.9 mg cm⁻² or more, 1 mg cm⁻² or more, 1.5 mg cm⁻² or more, 2 mg cm⁻² or more, 2.5 mg cm⁻² or more, 3 mg cm⁻² or more, 3.5 mg cm⁻² or more, 4 mg cm⁻² or more, 4.5 mg cm⁻² or more, 5 mg cm⁻² or more, 5.5 mg cm⁻² or more, 6 mg cm⁻² or more, 6.5 mg cm⁻² or more, 7 mg cm⁻² or more, 7.5 mg cm⁻² or more, 8 mg cm⁻² or more, 8.5 mg cm⁻² or more, 9 mg cm⁻² or more, or 9.5 mg cm⁻² or more). In some examples, the loading of the catalyst on the electrode can be 10 mg cm⁻² or less (e.g., 9.5 mg cm⁻¹ or less, 9 mg cm⁻² or less, 8.5 mg cm⁻² or less, 8 mg cm⁻² or less, 7.5 mg cm⁻² or less, 7 mg cm⁻² or less, 6.5 mg cm⁻² or less, 6 mg cm⁻² or less, 5.5 mg cm⁻² or less, 5 mg cm⁻² or less, 4.5 mg cm⁻² or less, 4 mg cm⁻² or less, 3.5 mg cm⁻² or less, 3 mg cm⁻² or less, 2.5 mg cm⁻² or less, 2 mg cm⁻² or less, 1.5 mg cm⁻² or less, 1 mg cm⁻² or less, 0.9 mg cm⁻² or less, 0.8 mg cm⁻² or less, 0.7 mg cm⁻² or less, or 0.6 mg cm⁻² or less). The loading of the catalyst on the electrode can range from any of the minimum values described above to any of the maximum values described above. In some examples, the loading of the catalyst on the electrode can be from 0.5 mg cm⁻² to 10 mg cm⁻² (e.g., from 0.5 mg cm⁻² to 5 mg cm⁻², from 5 mg cm⁻² to 10 mg cm⁻², from 0.5 mg cm⁻² to 2.5 mg cm⁻² from 2.5 mg cm⁻² to 5 mg cm⁻², from 5 mg cm⁻² to 7.5 mg cm⁻², from 7.5 mg cm⁻² to 10 mg cm⁻², or from 1 mg cm⁻² to 9 mg cm⁻²). In some examples, the loading of the catalyst on the electrode is 1.0 mg cm⁻² or more.

The catalytic activity of the catalyst can, for example, be measured using cyclic voltammetry. In some examples of the electrodes described herein, the current density for the oxidation of a fuel on the catalyst can be 0 mA cm⁻² or more in the potential range of −0.7 to 0.1 V as measured against a standard hydrogen electrode (SHE) (e.g., 0.1 mA cm⁻² or more, 0.2 mA cm⁻² or more, 0.3 mA cm⁻² or more, 0.4 mA cm⁻² or more, 0.5 mA cm⁻² or more, 0.6 mA cm⁻² or more, 0.7 mA cm⁻² or more, 0.8 mA cm⁻² or more, 0.9 mA cm⁻² or more, 1 mA cm⁻² or more, 1.5 mA cm⁻² or more, 2 mA cm⁻² or more, 2.5 mA cm⁻² or more, 3 mA cm⁻² or more, 3.5 mA cm⁻² or more, 4 mA cm⁻² or more, 4.5 mA cm⁻² or more, 5 mA cm⁻² or more, 5.5 mA cm⁻² or more, 6 mA cm⁻² or more, 6.5 mA cm⁻² or more, 7 mA cm⁻² or more, 7.5 mA cm⁻² or more, 8 mA cm⁻² or more, 8.5 mA cm⁻² or more, 9 mA cm⁻² or more, or 9.5 mA cm⁻² or more). In some examples of the electrodes described herein, the current density for the oxidation of a fuel on the catalyst can be 10 mA cm⁻² or less in the potential range of −0.7 to 0.1 V as measured against a standard hydrogen electrode (SHE) (e.g., 9.5 mA cm⁻² or less, 9 mA cm⁻² or less, 8.5 mA cm⁻² or less, 8 mA cm⁻² or less, 7.5 mA cm⁻² or less, 7 mA cm⁻² or less, 6.5 mA cm⁻² or less, 6 mA cm⁻² or less, 5.5 mA cm⁻² or less, 5 mA cm⁻² or less, 4.5 mA cm⁻¹ or less, 4 mA cm⁻² or less, 3.5 mA cm⁻² or less, 3 mA cm⁻² or less, 2.5 mA cm⁻² or less, 2 mA cm⁻² or less, 1.5 mA cm⁻² or less, 1 mA cm⁻² or less, 0.9 mA cm⁻² or less, 0.8 mA cm⁻² or less, 0.7 mA cm⁻² or less, 0.6 mA cm⁻² or less, 0.5 mA cm⁻² or less, 0.4 mA cm⁻² or less, 0.3 mA cm⁻² or less, 0.2 mA cm⁻² or less, or 0.1 mA cm⁻² or less). The current density for the oxidation of a fuel on the catalyst on the electrodes can range from any of the minimum values described above to any of the maximum values described above. In some examples of the electrodes described herein, the current density for the oxidation of a fuel on the catalyst can be from 0 mA cm⁻² to 10 mA cm⁻² in the potential range of −0.7 to 0.1 V as measured against a standard hydrogen electrode (SHE) (e.g., from 0 mA cm⁻² to 5 mA cm², from 5 mA cm⁻² to 10 mA cm⁻², from 0 mA cm⁻² to 2 mA cm⁻², from 2 mA cm⁻² to 4 mA cm⁻², from 4 mA cm⁻² to 6 mA cm⁻², from 6 mA cm⁻² to 8 mA cm⁻² from 8 mA cm⁻² to 10 mA cm⁻², from 0 mA cm⁻² to 8 mA cm⁻², from 0 mA cm⁻² to 6 mA cm⁻², from 0 mA cm⁻² to 4 mA cm⁻², or from 0 mA cm⁻² to 1 mA cm⁻²). In some examples, the current density for the oxidation of a fuel on the catalyst can be 1 mA cm² or less in the potential range of −0.7 to 0.1 V as measured against a standard hydrogen electrode (SHE).

In some examples of the electrodes described herein, the oxygen reduction reaction onset potential on the catalyst can be 0.9 V or more as measured against a reversible hydrogen electrode (RHE) (e.g., 0.905 V or more, 0.910 V or more, 0.915 V or more, 0.920 V or more, 0.925 V or more, 0.930 V or more, 0.935 V or more, 0.940 V or more, 0.945 V or more, 0.950 V or more, 0.955 V or more, 0.960 V or more, 0.965 V or more, 0.970 V or more, 0.975 V or more, 0.980 V or more, 0.985 V or more, 0.990 V or more, or 0.995 V or more). In some examples of the electrodes described herein, the oxygen reduction reaction onset potential on the catalyst can be 1.0 V or less as measured against a reversible hydrogen electrode (RHE) (e.g., 0.995 V or less, 0.990 V or less, 0.985 V or less, 0.980 V or less, 0.975 V or less, 0.970 V or less, 0.965 V or less, 0.960 V or less, 0.955 V or less, 0.950 V or less, 0.945 V or less, 0.940 V or less, 0.935 V or less, 0.930 V or less, 0.925 V or less, 0.920 V or less, 0.915 V or less, 0.910 V or less, or 0.905 V or less). The oxygen reduction reaction onset potential on the catalyst for the electrode can range from any of the minimum values described above to any of the maximum values described above. In some examples of the electrodes described herein, the oxygen reduction reaction onset potential on the catalyst can be from 0.9 V to 1.0 V as measured against a reversible hydrogen electrode (RHE) (e.g., from 0.9 V to 0.95 V, from 0.95 V to 1.0 V, from 0.9 V to 0.92 V, from 0.92 V to 0.96 V, from 0.96 V to 0.98 V, from 0.98 V to 1.0 V, from 0.91 V to 0.99 V, or from 0.94 V to 0.97).

In some examples of the electrodes described herein, the oxygen reduction reaction peak potential on the catalyst can be 0.85 V or more (e.g., 0.855 V or more, 0.860 V or more, 0.865 V or more, 0.870 V or more, 0.875 V or more, 0.880 V or more, 0.885 V or more, 0.890 V or more, 0.895 V or more, 0.900 V or more, 0.905 V or more, 0.910 V or more, 0.915 V or more, 0.920 V or more, 0.925 V or more, 0.930 V or more, 0.935 V or more, 0.940 V or more, or 0.945 V or more). In some examples of the electrodes described herein, the oxygen reduction reaction peak potential on the catalyst can be 0.95 V or less (e.g., 0.945 V or less, 0.940 V or less, 0.935 V or less, 0.930 V or less, 0.925 V or less, 0.920 V or less, 0.915 V or less, 0.910 V or less, 0.905 V or less, 0.900 V or less, 0.895 V or less, 0.890 V or less, 0.885 V or less, 0.880 V or less, 0.875 V or less, 0.870 V or less, 0.865 V or less, 0.860 V or less, or 0.855 V or less). The oxygen reduction reaction peak potential on the catalyst of the electrode can range from any of the minimum values described above to any of the maximum valued described above. In some examples of the electrodes described herein, the oxygen reduction reaction peak potential on the catalyst can be from 0.85 V to 0.95 V as measured against a reversible hydrogen electrode (RHE) (e.g., from 0.85 V to 0.90 V, from 0.90 V to 0.95 V, from 085 V to 0.87 V, from 0.87 V to 0.89 V, from 0.89 V to 0.91 V, from 0.91 V to 0.93 V, from 0.93 V to 0.95 V, or from 0.87 V to 0.90 V).

In some examples, the electrodes described herein can be used as a cathode in a battery (e.g., a rechargeable metal-air battery).

In some examples, the electrodes described herein can be used as a cathode in a fuel cell. In some examples, the electrodes described herein can be used as a cathode in a membraneless direct liquid fuel cell.

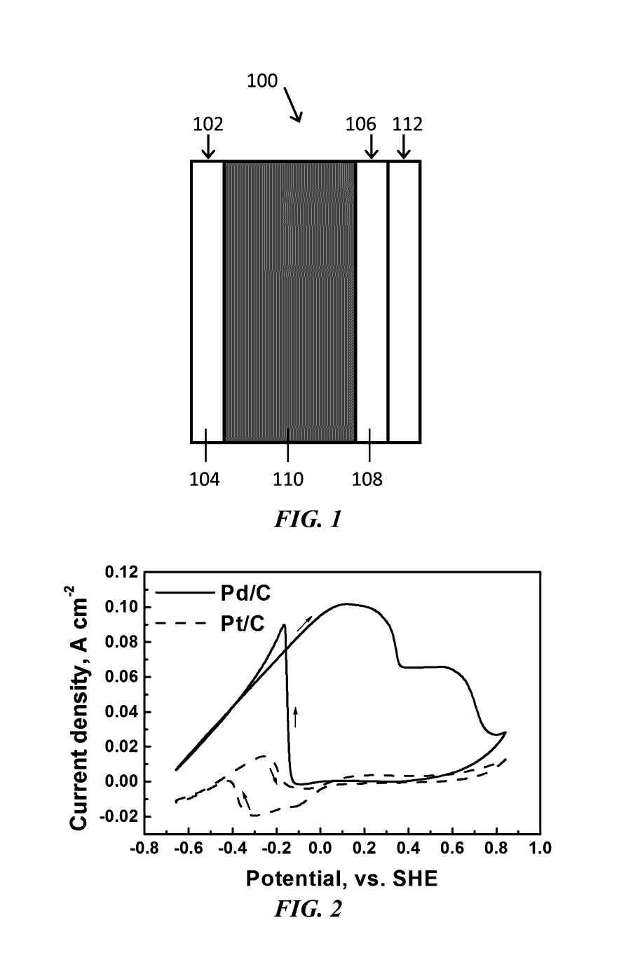

Also described herein are membraneless direct liquid fuel cells. Referring now to FIG. 1, the membraneless direct liquid fuel cell 100 can comprise an anode 102 comprising an anode catalyst 104 in electrochemical contact with an aqueous solution 110. The aqueous solution 110 can comprise a fuel, an electrolyte, and water. In some examples, the fuel can comprise an organic liquid (e.g., alcohols, polyols). In some examples, the fuel can be selected from the group consisting of methanol, ethanol, ethylene glycol, and glycerol. In some examples, the fuel comprises formate.

In some examples, the pH of the aqueous solution 110 is greater than 7 (e.g., 7.5 or more, 8 or more, 8.5 or more, 9 or more, 9.5 or more, 10 or more, 10.5 or more, 11 or more, 11.5 or more, 12 or more, 12.5 or more, 13 or more, or 13.5 or more).

The anode catalyst 104 is catalytically active for the oxidation of the fuel. In some examples, the anode catalyst 104 can comprise a precious metal, a non-precious metal, or combinations thereof. The precious metal can, for example, be selected from the group consisting of Pd. Ag, Pt, Au, and combinations thereof. In some examples, the anode catalyst 104 comprises Pd. In some examples, the anode catalyst 104 can comprise Pd/C, PdCu % C, PdPb/C, PdBi/C, PdSb/C, PtRu/C. PtPb/C, PtBi/C, PtSn/C, Ni, or combinations thereof.

In some examples, the current density for the oxidation of the fuel on the anode catalyst 104 can be 0 mA cm⁻² or more in the potential range of −0.7 to 0.1 V as measured against a standard hydrogen electrode (SHE) (e.g., 5 mA cm⁻² or more, 10 mA cm⁻² or more, 15 mA cm⁻² or more, 20 mA cm⁻² or more, 25 mA cm⁻² or more, 50 mA cm⁻² or more, 75 mA cm⁻² or more, 100 mA cm⁻² or more, 125 mA cm⁻² or more, 150 mA cm⁻² or more, 175 mA cm⁻² or more, 200 mA cm⁻² or more, 225 mA cm⁻² or more, 250 mA cm⁻² or more, 275 mA cm⁻² or more, 300 mA cm⁻² or more, 325 mA cm⁻² or more, 350 mA cm⁻² or more, 375 mA cm⁻² or more, 400 mA cm⁻² or more, 425 mA cm⁻² or more, 450 mA cm⁻² or more, 475 mA cm⁻² or more, 500 mA cm⁻² or more, 550 mA cm⁻² or more, 600 mA cm⁻² or more, 650 mA cm⁻² or more, 700 mA cm⁻² or more, 750 mA cm⁻² or more, 800 mA cm⁻² or more, 850 mA cm⁻² or more, 900 mA cm⁻² or more, or 950 mA cm⁻² or more). In some examples, the current density for the oxidation of the fuel on the anode catalyst 104 can be 1000 mA cm⁻² or less in the potential range of −0.7 to 0.1 V as measured against a standard hydrogen electrode (SHE) (e.g., 950 mA cm⁻² or less, 900 mA cm⁻² or less, 850 mA cm⁻² or less, 800 mA cm⁻² or less, 750 mA cm⁻² or less, 700 mA cm⁻² or less, 650 mA cm⁻² or less, 600 mA cm⁻² or less, 550 mA cm⁻² or less, 500 mA cm⁻² or less, 475 mA cm⁻² or less, 450 mA cm⁻² or less, 425 mA cm⁻² or less, 400 mA cm⁻² or less, 375 mA cm⁻² or less, 350 mA cm⁻² or less, 325 mA cm⁻² or less, 300 mA cm⁻² or less, 275 mA cm⁻² or less, 250 mA cm⁻² or less, 225 mA cm⁻² or less, 200 mA cm⁻² or less, 175 mA cm⁻² or less, 150 mA cm⁻² or less, 125 mA cm⁻² or less, 100 mA cm⁻² or less, 75 mA cm⁻² or less, 50 mA cm⁻² or less, 25 mA cm⁻² or less, 20 mA cm⁻² or less, 15 mA cm⁻² or less, 10 mA cm⁻² or less, or 5 mA cm⁻² or less).

The current density for the oxidation of the fuel on the anode catalyst 104 in the potential range of −0.7 to 0.1 V as measured against a standard hydrogen electrode (SHE) can range from any of the minimum values described above to any of the maximum values described above. In some examples, the current density for the oxidation of the fuel on the anode catalyst 104 can be from 0 mA cm⁻² to 1000 mA cm⁻² in the potential range of −0.7 to 0.1 V as measured against a standard hydrogen electrode (SHE) (e.g., from 0 mA cm⁻² to 500 mA cm⁻², from 500 mA cm⁻² to 1000 mA cm⁻², from 0 mA cm⁻² to 250 mA cm⁻¹ 2, from 250 mA cm⁻² to 500 mA cm⁻², from 500 mA cm⁻² to 750 mA cm⁻², from 750 mA cm⁻² to 1000 mA cm⁻², from 0 mA cm⁻² to 100 mA cm⁻², from 100 mA cm⁻² to 200 mA cm⁻², from 200 mA cm⁻² to 300 mA cm⁻², from 300 mA cm⁻² to 400 mA cm⁻², from 400 mA cm⁻² to 500 mA cm⁻², from 500 mA cm⁻² to 600 mA cm⁻², from 600 mA cm⁻² to 700 mA cm⁻², from 700 mA cm⁻² to 800 mA cm⁻², from 800 mA cm⁻² to 900 mA cm⁻², from 900 mA cm⁻² to 1000 mA cm⁻², from 25 mA cm⁻² to 900 mA cm⁻², or from 25 mA cm⁻² to 475 mA cm⁻²). In some examples, the current density for the oxidation of the fuel on the anode catalyst 104 can be 20 mA cm⁻² or more in the potential range of −0.7 to 0.1 V as measured against a standard hydrogen electrode (SHE).

In some examples, the rate of oxidation of the fuel on the anode catalyst 104 is substantially stable (e.g., the current density decays 0.2% or less after 100 hours of operation).

The loading of the anode catalyst 104 on the anode 102 (e.g., the weight of anode catalyst 104 per unit area of the anode 102) can be, for example, 0.5 mg cm⁻² or more (e.g., 0.6 mg cm⁻² or more, 0.7 mg cm⁻² or more, 0.8 mg cm⁻² or more, 0.9 mg cm⁻² or more, 1 mg cm⁻² or more, 1.5 mg cm⁻² or more, 2 mg cm⁻² or more, 2.5 mg cm⁻² or more, 3 mg cm⁻² or more, 3.5 mg cm⁻² or more, 4 mg cm⁻² or more, 4.5 mg cm⁻² or more, 5 mg cm⁻² or more, 5.5 mg cm⁻² or more, 6 mg cm⁻² or more, 6.5 mg cm⁻² or more, 7 mg cm² or more, 7.5 mg cm⁻² or more, 8 mg cm⁻² or more, 8.5 mg cm² or more, 9 mg cm⁻² or more, or 9.5 mg cm⁻² or more). In some examples, the loading of the anode catalyst 104 on the anode 102 can be 10 mg cm⁻² or less (e.g., 9.5 mg cm⁻² or less, 9 mg cm⁻² or less, 8.5 mg cm⁻² or less, 8 mg cm⁻² or less, 7.5 mg cm² or less, 7 mg cm⁻² or less, 6.5 mg cm⁻² or less, 6 mg cm⁻² or less, 5.5 mg cm⁻² or less, 5 mg cm⁻² or less, 4.5 mg cm⁻² or less, 4 mg cm⁻² or less, 3.5 mg cm⁻² or less, 3 mg cm⁻² or less, 2.5 mg cm⁻² or less, 2 mg cm⁻² or less, 1.5 mg cm⁻² or less, 1 mg cm⁻² or less, 0.9 mg cm² or less, 0.8 mg cm⁻² or less, 0.7 mg cm⁻² or less, or 0.6 mg cm⁻² or less). The loading of the anode catalyst 104 on the anode 102 can range from any of the minimum values described above to any of the maximum values described above. In some examples, the loading of the anode catalyst 104 on the anode 102 (e.g., the weight of anode catalyst 104 per unit area of the anode 102) can be from 0.5 mg cm⁻² to 10 mg cm⁻² (e.g., from 0.5 mg cm⁻² to 5 mg cm⁻², from 5 mg cm⁻² to 10 mg cm⁻², from 0.5 mg cm² to 2.5 mg cm⁻², from 2.5 mg cm⁻² to 5 mg cm², from 5 mg cm⁻² to 7.5 mg cm⁻², from 7.5 mg cm⁻² to 10 mg cm⁻², or from 1 mg cm⁻² to 9 mg cm⁻²). In some examples, the loading of the anode catalyst 104 on the anode 102 is 1.0 mg cm⁻² or more.

In some examples, the membraneless direct liquid fuel cell 100 can further comprise a cathode 106 comprising a cathode catalyst 108 in electrochemical contact with the aqueous solution 110.

In some examples, the membraneless direct liquid fuel cell 100 can further comprise an oxygen source 112 in electrochemical contact with the cathode catalyst 108. In some examples, the oxygen source 112 can comprise air, oxygen, a peroxide, or a combination thereof.

The cathode catalyst 108 is catalytically active for the reduction of oxygen and is substantially catalytically inactive for the oxidation of the fuel. In some examples, the cathode catalyst 108 can comprise a noble metal, a metal oxide, a carbon-based catalyst, or combinations thereof. The noble metal can, for example, be selected from the group consisting of Ru. Rh, Pd, Ag, Os, Ir, Pt, Au, and combinations thereof. The metal oxide can, for example, comprise a metal selected from the group consisting of Ti, V, Cr, Mn, Fe, Co, Ni. Cu. Zr, Nb, Mo, Tc, Ru, Rh, Pd. Ag, Hf, Ta, W, Re, Os, Ir, Pt, Au, La, Ce, Pr, Nd, Pm, Sm, Eu, Gd, Tb, Dy, Ho, Er, Tm. Yb, and combinations thereof. In some examples, the metal oxide can comprise a binary metal oxide. In some examples, the metal oxide can comprise a manganese-cobalt oxide (e.g., MnCo₂O₄). In some examples, the metal oxide can comprise a nickel-cobalt oxide (e.g., NiCo₂O₄). In some examples, the metal oxide can comprise a ternary metal oxide. In some examples, the metal oxide can comprise a manganese-nickel-cobalt oxide (e.g., MnNiCoO₄). In some examples, the metal oxide can comprise a quaternary metal oxide.

In some examples, the cathode catalyst 108 can comprise 10 percent by weight (wt. %) or more of the plurality of metal oxide particles (e.g., 15 wt. %6 or more, 20 wt. %6 or more, 25 wt. % or more, 30 wt. % or more, 35 wt. % or more, 40 wt. % or more, 45 wt. % or more, 50 wt. % or more, 55 wt. % or more, 60 wt. % or more, 65 wt. % or more, 70 wt. % or more, or 75 wt. % or more). In some examples, the cathode catalyst 108 can comprise 80 wt. % or less of the plurality of metal oxide particles (e.g., 75 wt. % or less, 70 wt. % or less, 65 wt. % or less, 60 wt. % or less, 55 wt. % or less, 50 wt. % or less, 45 wt. % or less, 40 wt. % or less, 35 wt. % or less, 30 wt. % or less, 25 wt. % or less, 20 wt. % or less, or 15 wt. % or less). The percent by weight of the plurality of metal oxide particles of the cathode catalyst 108 can range from any of the minimum values described above to any of the maximum values described above.

In some examples, the cathode catalyst 108 can comprise a plurality of particles comprising the metal oxide deposited on a carbon material. In certain examples, the cathode catalyst 108 can comprise from 10 to 80 percent by weight of the plurality of metal oxide particles (e.g., from 10 wt. % to 45 wt. %, from 45 wt. % to 80 wt. %, from 10 wt. % to 20 wt. %, from 20 wt. % to 30 wt. %, from 30 wt. % to 40 wt. %, from 40 wt. % to 50 wt. %, from 50 wt. % to 60 wt. %, from 60 wt. %6 to 70 wt. %, from 70 wt. % to 80 wt. %, from 20 wt. % to 80 wt. %, from 20 wt. % to 70 wt. %, from 30 wt. % to 60 wt. %, or from 35 wt. % to 55 wt. %).

In some examples, the cathode catalyst 108 can comprise 40 percent by weight (wt. %) of the plurality of metal oxide particles or more (e.g., 40.5 wt. % or more, 41 wt. % or more, 41.5 wt. %6 or more, 42 wt. %6 or more, 42.5 wt. % or more, 43 wt. % or more, 43.5 wt. % or more, 44 wt. % or more, or 44.5 wt. % or more). In some examples, the cathode catalyst 108 can comprise 45 wt. % of the plurality of metal oxide particles or less (e.g., 44.5 wt. % or less, 44 wt. % or less, 43.5 wt. % or less, 43 wt. % or less, 42.5 wt. % or less, 42 wt. % or less, 41.5 wt. % or less, 41 wt. % or less, or 40.5 wt. % or less).

The percent by weight of the plurality of metal oxide particles of the cathode catalyst 108 can range from any of the minimum values described above to any of the maximum values described above. In some examples, the cathode catalyst 108 can comprise from 40 wt. % to 45 wt. % of the plurality of metal oxide particles (e.g., from 40 wt. % to 42.5 wt. %, from 42.5 wt. % to 45 wt. %, from 40 wt. % to 41 wt. %, from 41 wt. % to 42 wt. %, from 42 wt. % to 43 wt. %, from 43 wt. % to 44 wt. %, from 44 wt. % to 45 wt. %, or from 41 wt. % to 44 wt. %).

In some examples, the plurality of metal oxide particles can have an average maximum dimension (e.g., an average maximum dimension for spheroidal particles) of from 2 nm to 50 nm.

In some examples, the carbon material can comprise a plurality of carbon nanotubes. The carbon nanotubes can, for example, comprise multi-walled carbon nanotubes (MWCNT). In some examples, the carbon nanotubes can comprise nitrogen doped carbon nanotubes (N-CNT). In some examples, the carbon nanotubes can comprise nitrogen doped multi-walled carbon nanotubes (N-MWCNT). The carbon nanotubes can, for example, have a diameter of from 10 nm to 100 nm. In some examples, the carbon nanotubes can have a length of from 3 μm to 200 μm. In some examples, the carbon nanotubes have an aspect ratio (e.g., the ratio of length:diameter) of from 10 to 200.

In some examples, the carbon material can comprise graphene. In some examples, the carbon material can comprise nitrogen-doped graphene (N-graphene).

In some examples, the cathode catalyst 108 can comprises Pt, MnCo₂O₄/N-MWCNT (e.g., a plurality of MnCo₂O₄ particles deposited on a plurality of nitrogen doped multi-walled carbon nanotubes), MnNiCoO₄/N-MWCNT, NiCo₂O₄/N-graphene, or combinations thereof.

In some examples, the current density for the oxidation of a fuel on the cathode catalyst 108 can be 0 mA cm⁻² or more in the potential range of −0.7 to 0.1 V as measured against a standard hydrogen electrode (SHE) (e.g., 0.1 mA cm⁻² or more, 0.2 mA cm⁻² or more, 0.3 mA cm⁻² or more, 0.4 mA cm⁻² or more, 0.5 mA cm⁻² or more, 0.6 mA cm⁻² or more, 0.7 mA cm⁻² or more, 0.8 mA cm⁻² or more, 0.9 mA cm⁻² or more, 1 mA cm⁻² or more, 1.5 mA cm⁻² or more, 2 mA cm⁻² or more, 2.5 mA cm⁻² or more, 3 mA cm⁻² or more, 3.5 mA cm⁻² or more, 4 mA cm⁻² or more, 4.5 mA cm⁻² or more, 5 mA cm⁻² or more, 5.5 mA cm⁻² or more, 6 mA cm⁻² or more, 6.5 mA cm⁻² or more, 7 mA cm⁻² or more, 7.5 mA cm⁻² or more, 8 mA cm⁻² or more, 8.5 mA cm⁻² or more, 9 mA cm⁻² or more, or 9.5 mA cm⁻² or more). In some examples, the current density for the oxidation of a fuel on the cathode catalyst 108 can be 10 mA cm⁻² or less in the potential range of −0.7 to 0.1 V as measured against a standard hydrogen electrode (SHE) (e.g., 9.5 mA cm⁻² or less, 9 mA cm⁻² or less, 8.5 mA cm⁻² or less, 8 mA cm⁻² or less, 7.5 mA cm⁻² or less, 7 mA cm⁻² or less, 6.5 mA cm⁻² or less, 6 mA cm⁻² or less, 5.5 mA cm⁻² or less, 5 mA cm⁻² or less, 4.5 mA cm⁻² or less, 4 mA cm⁻² or less, 3.5 mA cm⁻² or less, 3 mA cm⁻² or less, 2.5 mA cm⁻² or less, 2 mA cm⁻² or less, 1.5 mA cm⁻² or less, 1 mA cm⁻² or less, 0.9 mA cm⁻² or less, 0.8 mA cm⁻² or less, 0.7 mA cm⁻² or less, 0.6 mA cm⁻² or less, 0.5 mA cm⁻² or less, 0.4 mA cm⁻² or less, 0.3 mA cm⁻² or less, 0.2 mA cm⁻² or less, or 0.1 mA cm⁻² or less). The current density for the oxidation of a fuel on the cathode catalyst 108 can range from any of the minimum values described above to any of the maximum values described above. In some examples, the current density for the oxidation of the fuel on the cathode catalyst 108 can be from 0 mA cm⁻² to 10 mA cm⁻² in the potential range of −0.7 to 0.1 V as measured against a standard hydrogen electrode (SHE) (e.g., from 0 mA cm⁻² to 5 mA cm⁻², from 5 mA cm⁻² to 10 mA cm⁻², from 0 mA cm⁻² to 2 mA cm⁻², from 2 mA cm⁻² to 4 mA cm⁻², from 4 mA cm⁻² to 6 mA cm⁻², from 6 mA cm⁻² to 8 mA cm⁻², from 8 mA cm⁻² to 10 mA cm⁻², from 0 mA cm⁻² to 8 mA cm⁻², from 0 mA cm⁻² to 6 mA cm⁻², from 0 mA cm⁻² to 4 mA cm⁻², or from 0 mA cm⁻² to 1 mA cm⁻²). In some examples, the current density for the oxidation of the fuel on the cathode catalyst 108 can be 1 mA cm⁻² or less in the potential range of −0.7 to 0.1 V as measured against a standard hydrogen electrode (SHE).

In some examples, the oxygen reduction reaction onset potential on the cathode catalyst 108 can be 0.9 V or more as measured against a reversible hydrogen electrode (RHE) (e.g., 0.905 V or more, 0.910 V or more, 0.915 V or more, 0.920 V or more, 0.925 V or more, 0.930 V or more, 0.935 V or more, 0.940 V or more, 0.945 V or more, 0.950 V or more, 0.955 V or more, 0.960 V or more, 0.965 V or more, 0.970 V or more, 0.975 V or more, 0.980 V or more, 0.985 V or more, 0.990 V or more, or 0.995 V or more). In some examples, the oxygen reduction reaction onset potential on the cathode catalyst 108 can be 1.0 V or less as measured against a reversible hydrogen electrode (RHE) (e.g., 0.995 V or less, 0.990 V or less, 0.985 V or less, 0.980 V or less, 0.975 V or less, 0.970 V or less, 0.965 V or less, 0.960 V or less, 0.955 V or less, 0.950 V or less, 0.945 V or less, 0.940 V or less, 0.935 V or less, 0.930 V or less, 0.925 V or less, 0.920 V or less, 0.915 V or less, 0.910 V or less, or 0.905 V or less). The oxygen reduction reaction onset potential on the cathode catalyst 108 can range from any of the minimum values described above to any of the maximum values described above. In some examples, the oxygen reduction reaction onset potential on the cathode catalyst 108 can be from 0.9 V to 1.0 V as measured against a reversible hydrogen electrode (RHE) (e.g., from 0.9 V to 0.95 V, from 0.95 V to 1.0 V, from 0.9 V to 0.92 V, from 0.92 V to 0.96 V, from 0.96 V to 0.98 V, from 0.98 V to 1.0 V, from 0.91 V to 0.99 V, or from 0.94 V to 0.97).

In some examples, the oxygen reduction reaction peak potential on the cathode catalyst 108 can be 0.85 V or more (e.g., 0.855 V or more, 0.860 V or more, 0.865 V or more, 0.870 V or more, 0.875 V or more, 0.880 V or more, 0.885 V or more, 0.890 V or more, 0.895 V or more, 0.900 V or more, 0.905 V or more, 0.910 V or more, 0.915 V or more, 0.920 V or more, 0.925 V or more, 0.930 V or more, 0.935 V or more, 0.940 V or more, or 0.945 V or more). In some examples, the oxygen reduction reaction peak potential on the cathode catalyst 108 can be 0.95 V or less (e.g., 0.945 V or less, 0.940 V or less, 0.935 V or less, 0.930 V or less, 0.925 V or less, 0.920 V or less, 0.915 V or less, 0.910 V or less, 0.905 V or less, 0.900 V or less, 0.895 V or less, 0.890 V or less, 0.885 V or less, 0.880 V or less, 0.875 V or less, 0.870 V or less, 0.865 V or less, 0.860 V or less, or 0.855 V or less). The oxygen reduction reaction peak potential on the cathode catalyst 108 can range from any of the minimum values described above to any of the maximum valued described above. In some examples, the oxygen reduction reaction peak potential on the cathode catalyst 108 can be from 0.85 V to 0.95 V as measured against a reversible hydrogen electrode (RHE) (e.g., from 0.85 V to 0.90 V, from 0.90 V to 0.95 V, from 085 V to 0.87 V, from 0.87 V to 0.89 V, from 0.89 V to 0.91 V, from 0.91 V to 0.93 V, from 0.93 V to 0.95 V, or from 0.87 V to 0.90 V).

The loading of the cathode catalyst 108 on the cathode 106 (e.g., the weight of cathode catalyst 108 per unit area of the cathode 106) can be, for example, 0.5 mg cm⁻² or more (e.g., 0.6 mg cm⁻² or more, 0.7 mg cm⁻² or more, 0.8 mg cm⁻² or more, 0.9 mg cm⁻² or more, 1 mg cm⁻² or more, 1.5 mg cm⁻² or more, 2 mg cm⁻² or more, 2.5 mg cm⁻² or more, 3 mg cm⁻² or more, 3.5 mg cm⁻² or more, 4 mg cm⁻² or more, 4.5 mg cm⁻² or more, 5 mg cm⁻² or more, 5.5 mg cm⁻² or more, 6 mg cm⁻² or more, 6.5 mg cm⁻² or more, 7 mg cm⁻² or more, 7.5 mg cm⁻² or more, 8 mg cm⁻² or more, 8.5 mg cm⁻² or more, 9 mg cm⁻² or more, or 9.5 mg cm⁻² or more). In some examples, the loading of the cathode catalyst 108 on the cathode 106 can be 10 mg cm⁻² or less (e.g., 9.5 mg cm⁻² or less, 9 mg cm⁻² or less, 8.5 mg cm⁻² or less, 8 mg cm⁻² or less, 7.5 mg cm⁻² or less, 7 mg cm⁻² or less, 6.5 mg cm⁻² or less, 6 mg cm⁻² or less, 5.5 mg cm⁻² or less, 5 mg cm⁻² or less, 4.5 mg cm⁻² or less, 4 mg cm⁻² or less, 3.5 mg cm⁻² or less, 3 mg cm⁻² or less, 2.5 mg cm⁻² or less, 2 mg cm⁻² or less, 1.5 mg cm⁻² or less, 1 mg cm⁻² or less, 0.9 mg cm⁻² or less, 0.8 mg cm⁻² or less, 0.7 mg cm⁻² or less, or 0.6 mg cm⁻² or less). The loading of the cathode catalyst 108 on the cathode 106 can range from any of the minimum values described above to any of the maximum values described above. In some examples, the loading of the cathode catalyst 108 on the cathode 106 (e.g., the weight of cathode catalyst 108 per unit area of the cathode 106) can be from 0.5 mg cm⁻² to 10 mg cm⁻² (e.g., from 0.5 mg cm⁻² to 5 mg cm⁻², from 5 mg cm⁻² to 10 mg cm⁻², from 0.5 mg cm⁻² to 2.5 mg cm⁻², from 2.5 mg cm⁻² to 5 mg cm⁻², from 5 mg cm⁻² to 7.5 mg cm⁻², from 7.5 mg cm⁻² to 10 mg cm⁻², or from 1 mg cm⁻² to 9 mg cm⁻²). In some examples, the loading of the cathode catalyst 108 on the cathode 106 can be 1.0 mg cm⁻² or more.

In some examples, the loading of the anode catalyst 104 on the anode 102 is substantially the same as the loading of the cathode catalyst 108 on the cathode 106.

In some examples, the open circuit voltage of the membraneless direct liquid fuel cell 100 can be 0.7 V or more (e.g., 0.71 V or more, 0.72 V or more, 0.73 V or more, 0.74 V or more, 0.75 V or more, 0.76 V or more, 0.77 V or more, 0.78 V or more, 0.79 V or more, 0.80 V or more, 0.81 V or more, 0.82 V or more, 0.83 V or more, 0.84 V or more, 0.85 V or more, 0.86 V or more, 0.87 V or more, 0.88 V or more, 0.89 V or more, 0.90 V or more, 0.91 V or more, 0.92 V or more, 0.93 V or more, 0.94 V or more, 0.95 V or more, 0.96 V or more, 0.97 V or more, 0.98 V or more, 0.99 V or more, 1.00 V or more, 1.01 V or more, 1.02 V or more, 1.03 V or more, 1.04 V or more, 1.05 V or more, 1.06 V or more, 1.07 V or more, 1.08 V or more, 1.09 V or more, 1.10 V or more, 1.11 V or more, 1.12 V or more, 1.13 V or more, 1.14 V or more, 1.15 V or more, 1.16 V or more, 1.17 V or more, 1.18 V or more, or 1.19 V or more).

In some examples, the open circuit voltage of the membraneless direct liquid fuel cell 100 can be 1.2 V or less (e.g., 1.19 V or less, 1.18 V or less, 1.17 V or less, 1.16 V or less, 1.15 V or less, 1.14 V or less, 1.13 V or less, 1.12 V or less, 1.11 V or less, 1.10 V or less, 1.09 V or less, 1.08 V or less, 1.07 V or less, 1.06 V or less, 1.05 V or less, 1.04 V or less, 1.03 V or less, 1.02 V or less, 1.01 V or less, 1.00 V or less, 0.99 V or less, 0.98 V or less, 0.97 V or less, 0.96 V or less, 0.95 V or less, 0.94 V or less, 0.93 V or less, 0.92 V or less, 0.91 V or less, 0.90 V or less, 0.89 V or less, 0.88 V or less, 0.87 V or less, 0.86 V or less, 0.85 V or less, 0.84 V or less, 0.83 V or less, 0.82 V or less, 0.81 V or less, 0.80 V or less, 0.79 V or less, 0.78 V or less, 0.77 V or less, 0.76 V or less, 0.75 V or less, 0.74 V or less, 0.73 V or less, 0.72 V or less, or 0.71 V or less).

The open circuit voltage of the membraneless direct liquid fuel cell 100 can range from any of the minimum values described above to any of the maximum values described above. In some examples, the open circuit voltage of the membraneless direct liquid fuel cell 100 can range from 0.7 V to 1.2 V (e.g., from 0.7 V to 0.95 V, from 0.95 V to 1.2 V, from 0.70 V to 0.80 V, from 0.80 V to 0.90 V, from 0.90 V to 1.0 V, from 1.0 V to 1.1 V, from 1.1 V to 1.2 V, from 1.0 V to 1.2 V, or from 0.8 V to 1.1 V). In some examples, the open circuit voltage of the membraneless direct liquid fuel cell 100 can be 1.05 V or more.

In some examples, the specific power of the membraneless direct liquid fuel cell 100 can be 40 mW cm⁻² or more (e.g., 50 mW cm⁻² or more, 75 mW cm⁻² or more, 100 mW cm⁻² or more, 125 mW cm⁻² or more, 150 mW cm⁻² or more, 175 mW cm⁻² or more, 200 mW cm⁻² or more, 225 mW cm⁻² or more, 250 mW cm⁻² or more, 275 mW cm⁻² or more, 300 mW cm⁻² or more, 325 mW cm⁻² or more, 350 mW cm⁻² or more, or 375 mW cm⁻² or more). In some examples, the specific power of the membraneless direct liquid fuel cell 100 can be 400 mW cm⁻² or less (e.g., 375 mW cm⁻² or less, 350 mW cm⁻² or less, 325 mW cm⁻² or less, 300 mW cm⁻² or less, 275 mW cm⁻² or less, 250 mW cm⁻² or less, 225 mW cm⁻² or less, 200 mW cm⁻² or less, 175 mW cm⁻² or less, 150 mW cm⁻² or less, 125 mW cm⁻² or less, 100 mW cm⁻² or less, 75 mW cm⁻² or less, or 50 mW cm⁻² or less). In some examples, the specific power of the membraneless direct liquid fuel cell 100 can be from 40 mW cm⁻² to 400 mW cm⁻² (e.g., from 40 mW cm⁻² to 225 mW cm⁻², from 225 mW cm⁻² to 400 mW cm⁻², from 40 mW cm⁻² to 100 mW cm⁻², from 100 mW cm⁻² to 200 mW cm⁻², from 200 mW cm⁻² to 300 mW cm⁻², from 300 mW cm⁻² to 400 mW cm⁻², or from 50 mW cm⁻² to 375 mW cm⁻²). In some examples, the specific power of the membraneless direct liquid fuel cell 100 can be 75 mW per mg of anode catalyst 104 at 60° C. In some examples, the specific power of the membraneless direct liquid fuel cell 100 is 90 mW cm⁻² at 50° C.

In some examples, the specific current of the membraneless direct liquid fuel cell 100 can be 10 mA cm⁻² or more (e.g., 20 mA cm⁻² or more, 30 mA cm⁻² or more, 40 mA cm⁻² or more, 50 mA cm⁻² or more, 60 mA cm⁻² or more, 70 mA cm⁻² or more, 80 mA cm⁻² or more, 90 mA cm⁻² or more, 100 mA cm⁻² or more, 150 mA cm⁻² or more, 200 mA cm⁻² or more, 250 mA cm⁻² or more, 300 mA cm⁻² or more, 350 mA cm⁻² or more, 400 mA cm⁻² or more, 450 mA cm⁻² or more, 500 mA cm⁻² or more, 550 mA cm⁻² or more, 600 mA cm⁻² or more, 650 mA cm⁻² or more, 700 mA cm⁻² or more, 750 mA cm⁻² or more, 800 mA cm⁻² or more, 850 mA cm⁻² or more, 900 mA cm⁻² or more, or 950 mA cm⁻² or more). In some examples, the specific current of the membraneless direct liquid fuel cell 100 can be 1000 mA cm⁻² or less (e.g., 950 mA cm⁻² or less, 900 mA cm⁻² or less, 850 mA cm⁻² or less, 800 mA cm⁻² or less, 750 mA cm⁻² or less, 700 mA cm⁻² or less, 650 mA cm⁻² or less, 600 mA cm⁻² or less, 550 mA cm⁻² or less, 500 mA cm⁻² or less, 450 mA cm⁻² or less, 400 mA cm⁻² or less, 350 mA cm⁻² or less, 300 mA cm⁻² or less, 250 mA cm⁻² or less, 200 mA cm⁻² or less, 150 mA cm⁻² or less, 100 mA cm⁻² or less, 90 mA cm⁻² or less, 80 mA cm⁻² or less, 70 mA cm⁻² or less, 60 mA cm⁻² or less, 50 mA cm⁻² or less, 40 mA cm⁻² or less, 30 mA cm⁻² or less, or 20 mA cm⁻² or less).

The specific current of the membraneless direct liquid fuel cell 100 can range from any of the minimum values described above to any of the maximum values described above. In some examples, the specific current of the membraneless direct liquid fuel cell 100 can be from 10 mA cm⁻² to 1000 mA cm⁻² (e.g., from 10 mA cm⁻² to 50 mA cm⁻², from 500 mA cm⁻² to 1000 mA cm⁻², from 10 mA cm⁻² to 200 mA cm⁻², from 200 mA cm⁻² to 400 mA cm⁻², from 400 mA cm⁻² to 600 mA cm⁻², from 600 mA cm⁻² to 800 mA cm⁻², from 800 mA cm⁻² to 1000 mA cm⁻², or from 50 mA cm⁻² to 950 mA cm⁻²).

In some examples, the specific current of the membraneless direct liquid fuel cell 100 can be 100 mA or more per mg of anode catalyst 104 (mg of net catalyst, not including the supportive carbon materials) at 0.6 V and 60° C. (e.g., 120 mA or more, 140 or more, 160 or more, 180 or more, 200 or more, 220 or more, 240 or more, 260 or more, 280 or more, 300 or more, 320 or more, 340 or more, 360 or more, 380 or more, 400 or more, 420 or more, 460 or more, or 480 or more). In some examples, the specific current of the membraneless direct liquid fuel cell 100 can be 500 mA or less per mg of anode catalyst 104 (mg of net catalyst, not including the supportive carbon materials) at 0.6 V and 60° C. (e.g., 480 mA or less, 460 mA or less, 440 mA or less, 420 mA or less, 400 mA or less, 380 mA or less, 360 mA or less, 340 mA or less, 320 mA or less, 300 mA or less, 280 mA or less, 260 mA or less, 240 mA or less, 220 mA or less, 200 mA or less, 180 mA or less, 160 mA or less, 140 mA or less, or 120 mA or less).

The specific current of the membraneless direct liquid fuel cell 100 per mg of anode catalyst 104 (mg of net catalyst, not including the supportive carbon materials) at 0.6 V and 60° C. can range from any of the minimum values described above to any of the maximum values described above. For example, the specific current of the membraneless direct liquid fuel cell 100 can be from 100 mA to 500 mA per mg of anode catalyst 104 (mg of net catalyst, not including the supportive carbon materials) at 0.6 V and 60° C. (e.g., from 100 mA to 300 mA, from 300 mA to 500 mA, from 100 mA to 200 mA, from 200 mA to 300 mA, from 300 mA to 400 mA, from 400 mA to 500 mA, from 100 mA to 400 mA, or from 100 mA to 150 mA). In some examples, the specific current of the membraneless direct liquid fuel cell 100 can be 120 mA cm⁻² at 0.6 V and 50° C.

### EXAMPLES

The following examples are set forth to illustrate the methods and results according to the disclosed subject matter. These examples are not intended to be inclusive of all aspects of the subject matter disclosed herein, but rather to illustrate representative methods and results. These examples are not intended to exclude equivalents and variations which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

### Example 1

Under the proton exchange membrane fuel cell operation conditions, the kinetics of the oxygen reduction reaction (ORR) in a weakly acidic environment is slow. The large overpotential for the oxygen reduction reaction constitutes a large portion of the total-cell voltage loss in proton exchange membrane based fuel cells (Yu X W and Ye S Y. J. Power Sources. 2007, 172, 133-144: Ralph T R and Hogarth M P. Platin. Met. Rev., 2002, 46, 3-14; Hiesgen R et al. Fuel Cells. 2006, 6, 425-431). In contrast, the oxygen reduction reaction kinetics in an alkaline medium is more facile. As such, alkaline direct methanol fuel cells and direct ethanol fuel cells based on anion-exchange membranes (AEM) have recently attracted attention (Varcoe J R and Slade R C T. Fuel Cells. 2005, 5, 187-200; Zeng R et al. Energy Environ. Sci., 2011, 4, 4925-4928). However, anion-exchange membrane technology is not yet reliable enough for alkaline fuel cell development and implementation in terms of efficiency, stability, and cost.

The direct methanol fuel cell and direct ethanol fuel cell technologies are facing other challenges, such as: (i) the high rate of methanol or ethanol fuel crossover from the anode to the cathode through the membrane can reduce the fuel utilization and can decrease the cell performance, limiting the concentrations of the fuels used in practical cells (Casalegno A and Marchesi R. J. Power Sources. 2008, 185, 318-330; James D D and Pickup P G. Electrochim. Acta. 2010, 55, 3824-3829); (ii) both the methanol and ethanol oxidation reaction kinetics can be slow, which can necessitate high loading of expensive catalysts (Zheng W et al. Energy Procedia, 2012, 28, 78-87: Zhou W J et al. Appl. Catal. B-Environ. 2003, 46, 273-285); and (iii) the toxicity of methanol (Demirci U B. J. Power Sources. 2007, 169, 239-246).

In comparison to direct methanol fuel cells and direct ethanol fuel cells, direct formic acid fuel cells utilizing formic acid as a fuel can have a high theoretical cell voltage and low fuel crossover, while the formic acid fuel can have facile oxidation kinetics (Aslam N M et al. Apcbee Proc., 2012, 3, 33-39). However, the acidic operating medium of a direct formic acid fuel cell can lead to slow oxygen reduction reaction kinetics. Use of formates, e.g., sodium or potassium formate, as fuels can allow for a fuel cell which is analogous to the direct formic acid fuel cell, but in an alkaline medium. Formate (HCOO⁻) can be oxidized on Pd catalysts in alkaline media, as indicated below (Jacobsen E et al. J Electroanal. Chem., 1968, 16, 351-&; Takamura T and Mochimar F. Electrochim. Acta. 1969, 14, 111-&; Tabemer P et al. Electrochim. Acta, 1976, 21, 439-440; Yepez O and Scharifker B R. Int. J. Hydrogen Energ., 2002, 27, 99-105).

COOH⁻+3OH⁻→CO₃²⁻+2H₂O+2e⁻ (1) or

COOH⁻+OH⁻→CO₂+H₂O+2e⁻ (2)

From a fundamental point of view, on the Pd/C electrode, the formate oxidation reaction (FOR) can follow a mechanism in accordance with reactions 3-5 below (Yepez O and Scharifker B R. Int. J. Hydrogen Energ., 2002, 27, 99-105; Nagle L C and Burke L D. J. Solid State Electr., 2010, 14, 1465-1479).

HCOO⁻_{ad}→H_{ad}+COO⁻_{ad} (3)

COO⁻_{ad}→CO₂+e⁻ (4)

H_{ad}+OH⁻→H₂O+e⁻ (5)

According to this mechanism, there is no surface CO poisoning during the formate oxidation reaction on Pd, and the oxidation of adsorbed COO⁻ and desorption of hydrogen each contributes one electron charge transfer. These features can be advantageous for developing alkaline direct format fuel cells (DFFCs), however, like other alkaline direct liquid fuel cells, further development of direct formate fuel cell technology can be limited by the lack of industrially viable anion-exchange membranes (Jiang J H and Wieckowski A. Electrochem. Commun., 2012, 18, 41-43; Bartrom A M and Haan J L. J. Power Sources, 2012, 214., 68-74: Nguyen T Q et al. Fuel Cells, 2013, 13, 922-926: Bartrom A M et al. J. Power Sources, 2013, 229, 234-238).

Discussed herein are membraneless alkaline direct formate fuel cells (DFFCs). The membraneless alkaline direct formate fuel cells can use a catalyst-selective strategy, in which a non-hazardous, inexpensive alkaline aqueous formate solution is used as an anolyte. In some examples of the membraneless alkaline direct formate fuel cells, the cathode catalyst (Pt) can exhibit catalytic activity for the oxygen reduction reaction but substantially no catalytic activity for the formate oxidation reaction (FOR). This can minimize crossover of the fuel to the cathode, allowing for a membraneless fuel cell (e.g., exclusion of a membrane, such as an alkaline anion exchange membrane).

The catalyst-selective strategy can avoid the use of alkaline anion-exchange membranes, can overcome the scalability limitations of traditional membraneless direct liquid fuel cells (DLFCs) based on micro-flow phenomenon, and can allow for the development of large-scale membraneless direct liquid fuel cells with flexible configurations. In comparison to methanol, ethanol, and formic acid fuels, aqueous formate solutions can have superior oxidation kinetics and efficiency. The high power density exhibited by the membraneless alkaline direct formate fuel cell can be used for developing small, safe, inexpensive portable power systems as well as large-scale energy generation systems.

Potassium formate and sodium formate from Alfa Aesar®, were dissolved in 1.0 M KOH and 1.0 M NaOH solutions, respectively, to form anolytes/electrolytes of varying concentrations. Methanol and ethanol from Fisher Scientific® were added to the 1.0 M KOH solution to form the aqueous alkaline electrolyte. Formic acid from Alfa Aesar®, was added to 1.0 M H₂SO₄ to form the aqueous acidic electrolyte.

Catalysts employed herein included 40% palladium supported on carbon (Pd/C; 40 wt. % Pd on Vulcan® XC-72, E-TEK), 40% platinum supported on carbon (Pt/C: 40 wt. % Pt on Vulcan® XC-72, E-TEK) and 40% platinum-ruthenium supported on carbon (PtRu/C; 40 wt. % Pt—Ru (Pt:Ru=1:1) on Vulcan® XC-72. E-TEK). Each catalyst was dispersed in a mixture of de-ionized (DI) water and a certain volume of Nafion solution (5%, DuPont®) by sonication for 10 min. The mass ratio of net Nafion to the catalyst was 1:4 in all cases. The resulting ink was deposited onto a carbon fiber paper (Toray HP-60) and dried in air for 1 h at room temperature.

Cyclic voltammetry and linear sweep voltammetry experiments were conducted in a conventional three-electrode glass cell with a Pt mesh counter electrode. Hg/HgO and Hg/Hg₂SO₄ reference electrodes were used in the alkaline and acidic electrolytes, respectively. The working electrodes were prepared by depositing 1.6 mg of the catalyst (including carbon support and Nafion) onto a strip of carbon fiber paper with an area of a 1.0 cm². The electrochemical data were collected with a potentiostat (VoltaLab PGZ 402, Radiometer Analytical).

FIG. 2 shows the cyclic voltammetry (CV) profiles of Pd:C (0.5 mg cm⁻² Pd) and Pt/C (0.5 mg cm⁻² Pt) electrodes in an electrolyte containing 1.0 M HCOOK in 1.0 M KOH. As seen in FIG. 2, the oxidation current of HCOOK on the Pd/C electrode increases almost linearly in the potential range of −0.7 to 0.1 V (vs. SHE), which is a matched potential domain for the alkaline fuel cell operation. The voltammetric behavior of the Pd/C electrode agrees with the mechanism of the formate oxidation reaction (FOR) on a pure Pd catalyst under similar conditions (Takamura T and Mochimar F. Electrochim. Acta. 1969, 14, 111-&; Taberner P et al. Electrochim. Acta, 1976, 21, 439-440; Yepez O and Scharifker B R. Int. J. Hydrogen Energ., 2002, 27, 99-105). It is difficult to discern the oxidation currents of the formate oxidation reaction from those caused by the hydrogen desorption, which can be due to the mechanism for the formate oxidation reaction on Pd in alkaline media (e.g., as described in equations 3-5).

Pt/C does not provide any significant catalytic activity for the oxidation of potassium formate (FIG. 2); the formate oxidation reaction current on the Pt/C electrode is almost negligible in contrast to that generated on the Pd/C electrode. The formate oxidation reaction on the Pt-based catalyst has scarcely been reported, but it was recently proposed that formation of CO intermediates and the presence of other possible inhibitory processes (such as OH adsorption) prevent the oxidation of formate on the Pt surface (John et al. J. Phys. Chem. C, 2012, 116, 5810-5820).

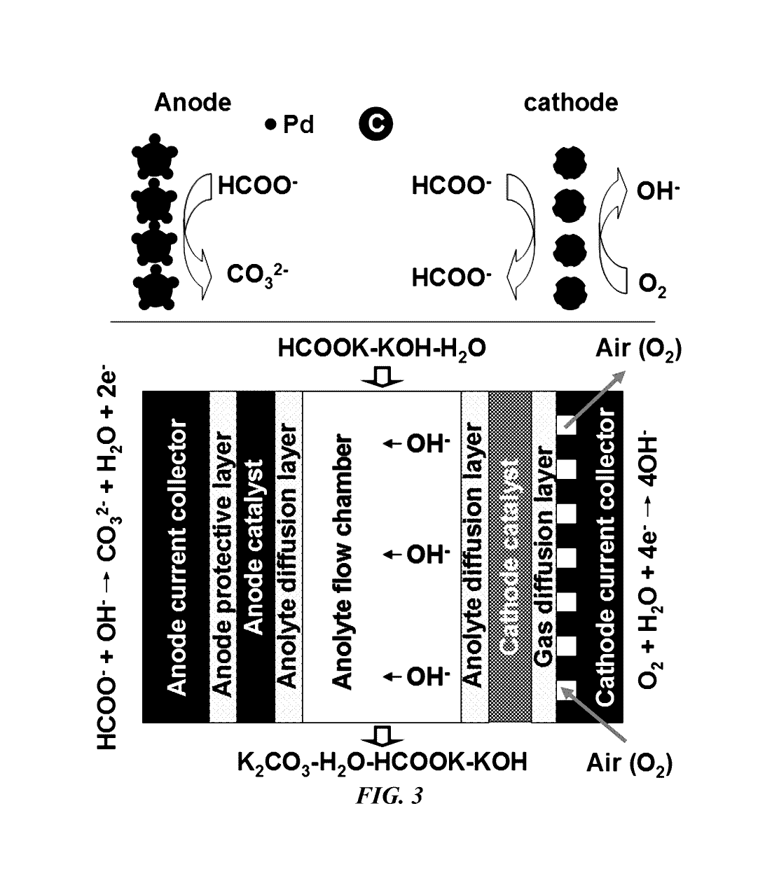

The cyclic voltammetry profile of the Pt:C electrode shown in FIG. 2 along with the ‘inhibitory mechanism’ (John et al. J. Phys. Chem. C, 2012, 116, 5810-5820) of formate oxidation reaction on Pt can be useful for developing a ‘membraneless’ direct formate fuel cell, such as those described herein. An exemplary membraneless direct formate fuel cell is illustrated in FIG. 3.

Pd/C and Pt/C were, respectively, used as anode and cathode catalysts in the exemplary membraneless direct formate fuel cell shown in FIG. 3. An aqueous solution comprising HCOOK as fuel and KOH as supporting electrolyte was fed as an anolyte through a chamber between the anode and the cathode catalyst layers. In traditional alkaline liquid-fed fuel cells, the alkaline anion-exchange membrane can provide a conductive path for the OH⁻ ion migration and prevent crossover of the liquid fuel and the oxidants. In the fuel cell shown in FIG. 3, the supporting electrolyte KOH can sustain the migration of OH⁻ ions. Since the cathode catalyst Pt does not catalyze the anode reaction, oxidation of potassium formate will not take place at the cathode. In addition, the low solubility and diffusivity of oxygen in an aqueous alkaline solution can minimize the crossover of the cathode oxidant (Gubbins K E and Walker R D. J. Electrochem. Soc., 1965, 112, 469-&; Davis R E et al. Electrochim. Acta, 1967, 12, 287-&). Therefore, the anion-exchange membrane used in the traditional alkaline direct liquid fuel cells is not necessary in this exemplary fuel cell.

In some example, such as shown in FIG. 3, two anolyte diffusion layers made of carbon fiber paper were applied to each side of the cell between the catalyst layers and the anolyte flow in order to prevent the anolyte flow washout to the catalyst. Two pieces of carbon fiber paper were additionally placed to each side of the cell between the catalyst layers and the current collectors: the one at the cathode can serve as a gas diffusion layer, and the other at the anode can protect the anode catalyst.

The operation of the membraneless alkaline direct formate fuel cell was examined using cell performance tests that were controlled with a fuel cell test station (850E, Scribner Associates Inc.). The cell performance tests for the membraneless direct formate fuel cell shown in FIG. 3 were performed with the operation of a cell with 5 cm² active electrodes (areas of the anode and the cathode were substantially the same) and a 2 mm thick flow chamber. For the single cell measurements, an anolyte solution containing 2.0 M HCOOK in 2.0 M KOH was pumped through the flow chamber at a flow rate of 0.5 mL min⁻¹. Oxygen was fed to the cathode at a flow rate of 100 mL min⁻¹, and the back pressure was maintained at 30 psi. The Pd loading at the anode and the Pt loading at the cathode were both 1.0 mg cm⁻². Cell performances were tested at various temperatures (e.g., at 30, 50, and 60° C.).

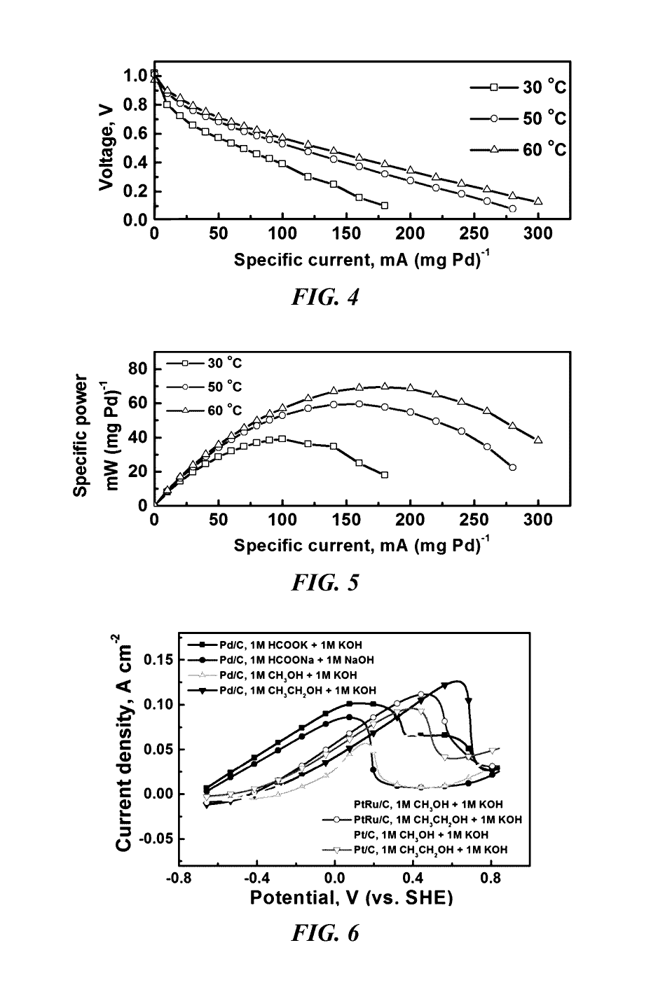

FIG. 4 and FIG. 5 show the polarization curves and the corresponding power plots, respectively, of the membraneless direct formate fuel cell operated at different temperatures. As seen in FIG. 4, the open-circuit voltage of the membraneless direct formate fuel cell is ca. 1.1 V, which is higher than the open-circuit voltages of direct methanol fuel cells, direct ethanol fuel cells, and direct formic acid fuel cells. Sufficient loading of the Pt catalyst was used in this cell such that the cathode reaction would not limit the performance of the cell. The specific current and specific power of the membraneless direct formate fuel cell was normalized based on the anode catalyst (Pd) loading. Under the testing conditions used herein at 60° C., the specific power of the membraneless direct formate fuel cell was ca. 75 mW (mg Pd)⁻¹ (FIG. 5) and the specific current at 0.6 V was ca. 100 mA (mg Pd)⁻¹ (FIG. 4). The performance shown herein for the membraneless direct formate fuel cell is comparable to direct formate fuel cells with an alkaline anion-exchange membrane (Jiang J H and Wieckowski A. Electrochem. Commun., 2012, 18, 41-43: Bartrom A M and Haan J L. J. Power Sources, 2012, 214, 68-74; Nguyen T Q et al. Fuel Cells, 2013, 13, 922-926: Bartrom A M et al. J. Power Sources, 2013, 229, 234-238) and alkaline direct alcohol fuel cells under the same catalyst loading (Bianchini C and Shen P K. Chem. Rev 2009, 109, 4183-4206: Yu E H et al. Energies. 2010, 3, 1499-1528).

Herein, Pd/C was used at the anode as Pd is a powerful and stable catalyst for the formate oxidation reaction. In comparison to Pt, Pd is less expensive (only ⅕ of the price of Pt). Pt:C was used as the cathode catalyst herein as it is a reliable catalyst. Since the cathode reaction proceeds more rapidly in alkaline media, the demands on the oxygen reduction reaction catalysts in the alkaline direct liquid fuel cells can be less, which can allow for a broader range of catalysts to be used. In some examples, non-noble metal catalysts can be used for the oxygen reduction reaction in alkaline medium. For example, alkaline direct ethanol fuel cells have been demonstrated recently with non-precious metal catalysts (Bianchini C et al. Electrochem. Commun., 2009, 11, 1077-1080; Li Y S et al. J. Power Sources, 2009, 187, 387-392).

Direct methanol fuel cells, direct ethanol fuel cells, and direct formic acid fuel cells are among the most common types of low-temperature direct liquid fuel cells. Herein, the anode reaction kinetics of the formates were compared with those of methanol, ethanol, and formic acid. In order to avoid the influence from the full cell operation conditions, the oxidation kinetics of the liquid fuels were compared with electrochemical experiments conducted in a three-compartment electrochemical cell. The concentration of each fuel (methanol, ethanol, potassium formate, sodium formate, or formic acid) was maintained at 1.0 M. The supporting electrolytes used for methanol, ethanol, potassium formate, and sodium formate were 1.0 M KOH or 1.0 M NaOH, while 1.0 M H₂SO₄ was used as the supporting electrolyte for formic acid. The electrodes were prepared with the best catalyst (with the same loading of 0.5 mg cm⁻²) as known for the oxidation of each fuel: PtRu/C and Pt/C catalysts were used for the study of methanol and ethanol, while Pd/C was used for the study of potassium formate, sodium formate, and formic acid. The average particle sizes of the Pt/C, PtRu/C, and Pd/C catalysts were substantially the same (˜2-4 nm), so the active surface area of the catalysts were similar as well.

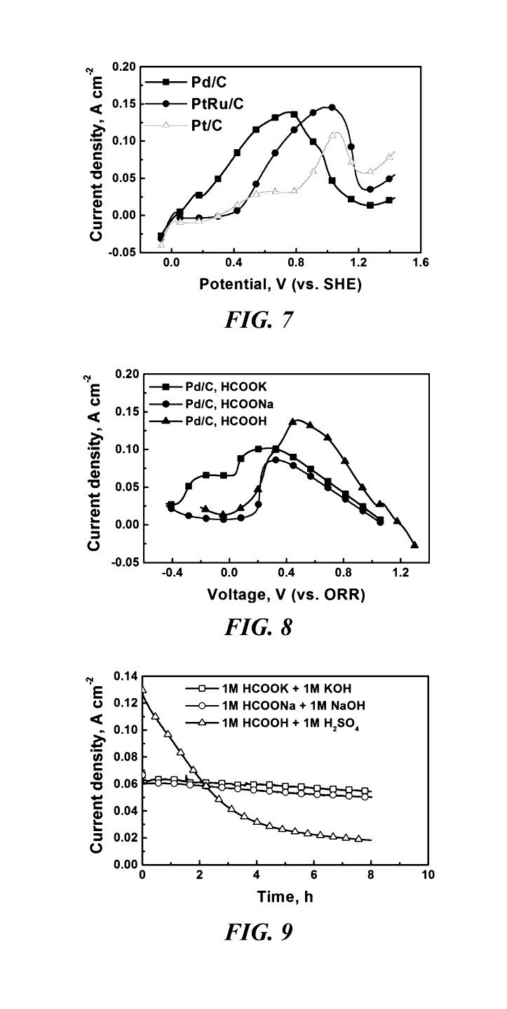

FIG. 6 shows the linear sweep voltammetry profiles of the PtRu/C, Pt/C, and Pd/C electrodes in 1.0 M CH₃OH+1.0 M KOH, 1.0 M CH₃CH₂OH+1.0 M KOH, 1.0 M HCOOK+1.0 M KOH, and 1.0 M HCOONa+1.0 M NaOH electrolytes, and FIG. 7 shows the linear sweep voltammetry profiles of the PtRu/C, Pt/C, and Pd/C electrodes in a 1.0 M HCOOH+1.0 M H₂SO₄ electrolyte. As seen in FIG. 6, in comparison to methanol and ethanol, potassium formate and sodium formate were oxidized more efficiently and at lower potentials. Throughout the potential domain, which is consistent with the fuel cell operation (−0.7 V to 0.1 V vs. SHE), the oxidation rates of the two formates were higher than those of methanol and ethanol. For the oxidation of formic acid, Pd/C shows the highest activity (FIG. 7).

The oxidation rates of the two formates and the formic acid are not directly comparable from the voltammetry profiles shown in FIG. 6 and FIG. 7, since direct formate fuel cells and direct formic acid fuel cells are operated in alkaline and acidic media, respectively. To make a direct comparison and study the oxidation kinetics of the formates and formic acid fuels at substantially identical fuel cell operating voltages, their voltammetry profiles are plotted by subtracting their oxidation potentials from the oxygen reduction reaction potentials in acidic (1.23 V vs. SHE) and alkaline (0.4 V vs. SHE) media (FIG. 8).

The results in FIG. 8 indicate that formic acid is more readily oxidized on the Pd/C catalyst in acidic media than its counterpart formates in alkaline media. However, due to the ‘dual pathway’ mechanism of the electro-oxidation of formic acid, the oxidation rate is not stable under direct formic acid fuel cell conditions (Yu X W and Pickup P G. J. Power Sources, 2009, 187, 493-499). FIG. 9 compares the long-term oxidation rates of potassium formate, sodium formate, and formic acid on Pd/C catalyst at a fixed fuel cell operation voltage of 0.65 V (vs. oxygen reduction reaction potentials in alkaline and acidic media, respectively). Although the initial oxidation currents for sodium formate and potassium formate are lower than that for formic acid, their currents are stable. Consequently, the oxidation currents of the two formates exceed that of formic acid after ca. 2 h of continuous operation. In consideration of both the activity and durability, the formate salts show superior practical oxidation characteristics than the other liquid fuels, including methanol, ethanol, and formic acid, that are commonly used in direct liquid fuel cells.

Like formic acid, the oxidation reaction of formate salts theoretically involves a 2-electron charge transfer (see equations 1 and 2), which is lower than those involved with the oxidation reactions of methanol (6-electron charge transfer) and ethanol (12-electron charge transfer). However, from the comparison results shown in FIGS. 6-9, the oxidation kinetics and efficiencies of the formates are superior to those of other liquid fuels, including methanol, ethanol, and formic acid. Based on thermodynamics, the open circuit potential of a direct formate fuel cell is about 1.45 V (as calculated from the Gibbs free energy change of a full cell reaction) (Jiang J H and Wieckowski A. Electrochem. Commun., 2012, 18, 41-43). Therefore, the direct formate fuel cells have a higher electromotive force (EMF) than either direct methanol fuel cells (open-circuit voltage=1.21 V) or direct ethanol fuel cells (open-circuit voltage=1.14 V) (Bartrom A M and Haan J L. J. Power Sources, 2012, 214, 68-74). Based on the superior oxidation kinetics of the formate fuel and the high electromotive force of the fuel cell reaction, the direct formate fuel cell system can generate higher practical energy than the other direct liquid fuel cells.

Under alkaline conditions, the electrode reactions can be more facile in a direct formate fuel cell with less expensive anode and cathode catalysts. Exclusion of the membrane can not only eliminates the use of inefficient and costly anion-exchange membranes, but can also simplify the cell configuration and lower the cell component cost.

Transitioning traditional lab-scale (e.g., proof of concept) membraneless fuel cells into commercially viable micro-fluidic power generation system can be challenging. Traditional membraneless fuel cells are usually based on a micro-flow phenomenon and rely on maintaining a laminar flow regime, making the transition of traditional lab-scale membraneless fuel cells into commercially viable micro-fluidic power generation system challenging as the scale-up of such fuel cells is not technically feasible (Shaegh S A M et al. Int. J. Hydrogen Energ., 2011, 36, 5675-5694). Meanwhile, the catalyst-selective strategy demonstrated herein can enable membraneless direct liquid fuel cells to be built in any scale and with flexible configurations.

From the fuel cell operation point of view, formate salts are non-hazardous and can be easily handled as stable solids or in aqueous solutions. The formate solutions in alkaline media are not volatile below the boiling point of water (100° C.), which is an additional advantage compared to methanol, ethanol, and formic acid. Furthermore, the products of formate salts are inexpensive and, in some examples, can be obtained from renewable sources via artificial photosynthesis. As illustrated in FIG. 3, the reaction products of direct formate fuel cells are carbonate and water. Therefore, the direct formate fuel cell systems can provide a safe, low-cost, and environmentally benign process for energy generation.

The catalyst selectivity strategy discussed herein can provide a new strategic pathway for developing membraneless direct liquid fuel cells. This strategy can not only avoid the need for expensive proton-change membranes and/or reliable alkaline anion-exchange membranes, but can also provide advantages such as scalability of direct liquid fuel cells with more flexibility in the cell-configuration design. Implementation of the catalyst selectivity strategy for membraneless fuel cells can be simpler than membraneless fuel cells that depend on non-mixing laminar flows. Herein, a catalyst-selective, membraneless strategy was demonstrated in an alkaline direct formate fuel cell system with facile electrode reactions, including both the electrooxidation of formate and the electroreduction of oxygen. The oxidation kinetics of the aqueous formate solutions were superior to those of other liquid fuels. The membraneless alkaline direct formate fuel cell system discussed herein can address the rapidly growing need for low-cost, large-scale energy generation and high-energy density portable power systems.

### Example 2

The oxygen reduction reaction in alkaline medium is more facile and can be catalyzed by a broader range of materials than in acidic medium (Spendelow J S and Wieckowski A. Phys. Chem. Chem. Phys. 2007, 9, 2654-2675). Metal oxides and doped carbon materials have recently been investigated as oxygen reduction reaction catalysts in alkaline solutions (Su D S et al. Chemsuschem., 2010, 3, 169-180; Roche I et al. J. Phys. Chem. C. 2007, 111, 1434-1443; Kim J H et al. Chem. Lett., 2007, 36, 514-515; Roche I et al. J. Appl. Electrochem., 2008, 38, 1195-1201: Ahmed J et al. J. Power Sources. 2012, 208, 170-175; Chen P et al. Adv. Mater., 2013, 25, 3192-3196; Xu Y F et al. Angew. Chem. Int. Edit., 2013, 52, 8546-8550; Meadower D B. Nature, 1970, 226, 847-848). However, the oxides and carbon materials usually exhibit lower mass activity compared to Pt-based catalysts.

In the membraneless alkaline direct formate fuel cell (DFFC) with a catalyst-selective strategy, as discussed above, the cathode catalyst (Pt) showed catalytic activity for the oxygen reduction reaction but almost no catalytic activity for the formate oxidation reaction (FOR). Herein, the catalyst-selective strategy is further investigated.

Discussed herein are nanocomposite electrocatalysts comprising MnNiCoO₄ nanoparticles on nitrogen-doped multi-wall carbon nanotube (N-MWCNT). In alkaline media, these catalysts exhibited activity for the oxygen reduction and evolution reactions, but substantially no activity for formate oxidation. The results discussed herein indicate that MnNiCoO₄ nanoparticles deposited onto nitrogen-doped carbon nanotubes (MnNiCoO₄/N-MWCNT) can exhibit even better catalytic selectivity (high oxygen reduction reaction activity but formate oxidation reaction inactivity) than Pt, demonstrating the MnNiCoO₄/N-MWCNT composite can be used as a cathode catalyst for the membraneless direct formate fuel cell system. In addition, the MnNiCoO₄/N-MWCNT nanocomposite exhibits high oxygen evolution reaction activity as well, demonstrating bifunctional activity which can be used for rechargeable metal-air batteries.

The MnNiCoO₄/N-MWCNT nanocomposite catalyst was synthesized by an impregnation-hydrothermal processes. Multiwall carbon nanotube (MWCNT) (US Research Nanomaterials, Inc.) powder was first pretreated (oxidized) by refluxing the MWCNT powder (0.2 g) in 50 mL of nitric acid at 80° C. for 4 h. The mixture was then cooled to room temperature and diluted with 100 mL of de-ionized (DI) water. The resulting solid was collected by centrifugation, washed with DI water several times, and dried at 50° C. under vacuum. For a typical synthesis herein, 0.51 mL of 0.6 M Mn(OAc)₂, 0.765 mL of 0.4 M Ni(OAc)₂, and 0.51 mL of 0.6 M Co(OAc)₂ aqueous solutions were added to a 30 mL ethanol solution with 0.1 g MWCNT suspension, followed by the addition of 2.5 mL of NH₄OH at room temperature (RT), which was used to mediate the nucleation of the metal species and provide a source for nitrogen doping. The reaction was kept at 80° C. with stirring for 24 h. After that, the above reaction mixture was transferred to an 80 mL autoclave for hydrothermal reaction at 150° C. for 3 h to obtain N-doping and crystallization of the metal oxide nanoparticles on MWCNT. The resulting product was collected by centrifugation and washed with ethanol and water. The MnNiCoO₄/N-MWCNT composite product was ˜170 mg after drying (˜41.0 wt. % MnNiCoO₄).

For a comparison, a binary metal oxide catalyst with the composition of MnCo₂O₄/N-MWCNT was also synthesized with the same procedure as above, but with appropriate amounts of Mn(OAc)₂ and Co(OAc)₂ precursors and MWCNT powder (molar ratio of Mn:Co=1:2 with a target MnCo₂O₄ content of 42.0 wt. % on N-MWCNT).

Morphological characterization of the catalysts was carried out with a Hitachi S-5500 scanning transmission electron microscope (STEM). Elemental mapping results were obtained with an energy-dispersive spectrometer (EDS) attached to the Hitachi S-5500 STEM. X-ray powder diffraction (XRD) data were collected on a Rigaku D/MAX-RC X-ray diffractometer equipped with Cu Kα radiation between 10° and 80° in a step of 0.02°. Raman spectra of the catalysts were collected with a Witec Alpha 300 micro-Raman confocal microscope. Transition-metal ratios in the samples were determined with a Varian 715-ES inductively coupled plasma-optical emission spectroscopy (ICP-OES) analyzer.

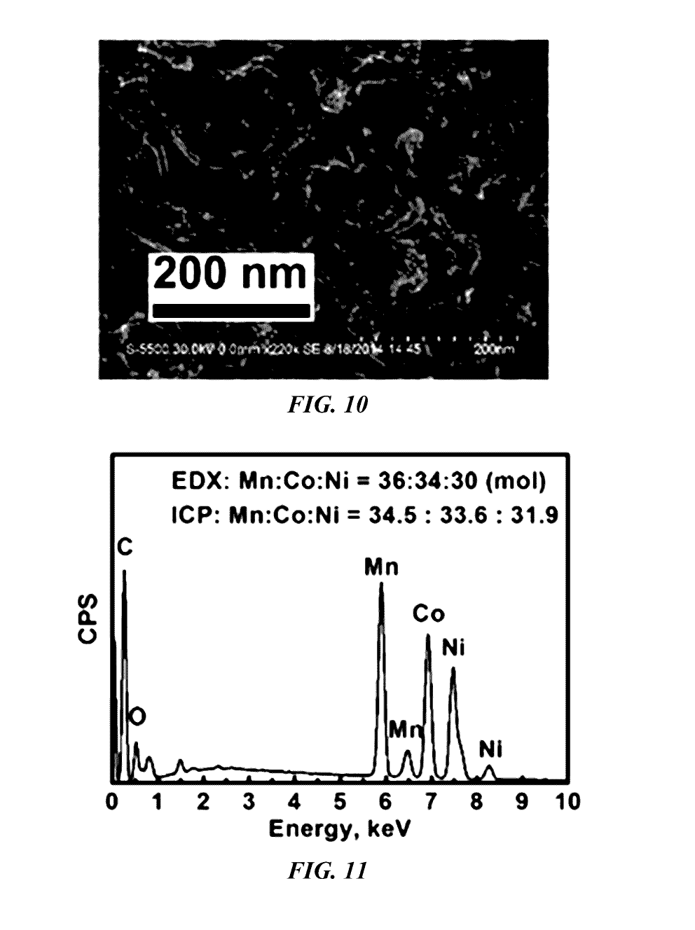

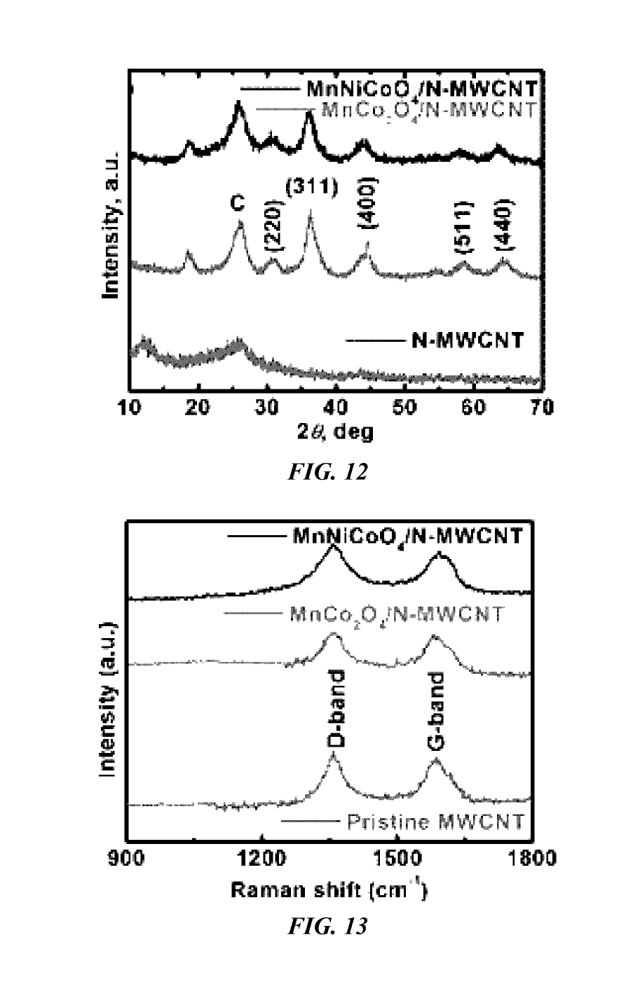

The scanning transmission electron microscopy (STEM) image of the synthesized MnNiCoO₄/N-MWCNT catalyst displayed in FIG. 10 indicates the formation of nanocrystals with a particle size of ˜5 nm on the MWCNT support. Energy dispersive spectroscopy (EDS) analysis (FIG. 11) indicated that the molar ratio of Mn:Co:Ni in the catalyst is 36:34:30. While the inductively coupled plasma (ICP) analysis reveals this ratio in the catalyst to be 34.5:33.6:31.9, which is close to the ratio of the Mn, Co, and Ni precursors used in the synthesis (Mn:Co:Ni=1:1:1). The MnNiCoO₄ loading on the MWCNT was ˜41.2 wt. % as determined by the weight gain of the MWCNT after the deposition of MnNiCoO₄. The X-ray diffraction (XRD) pattern of the MnNiCoO₄/N-MWCNT catalyst (FIG. 12) shows that the synthesized nanocrystals are single-phase with a cubic spinel structure (XRD pattern of the nitrogen doped MWCNT is also shown for comparison). Raman spectra of the MnNiCoO₄/N-MWCNT and the MnCo₂O₄/N-MWCNT catalysts (FIG. 13) show wider (higher ratio of the width to height after normalization) peaks for both the D and G bands in comparison to the pristine MWCNT, but there is no shift in peak position. The above phenomena indicate nitrogen-doping (Ewels C et al. Nitrogen and boron doping in carbon nanotubes, American Scientific Publishers, California, USA, 2007, 1-65).

Samples for cyclic voltammetry measurements were prepared by dispersing 10 mg of the powdered catalyst into a solution comprising of 800 μL DI water, 200 μL isopropanol (IPA), and 18 μL of a Nafion solution (15 wt. %) by sonication for 10 min to form a homogeneous ink. Then 5 μL of the catalyst ink was loaded onto a glassy carbon electrode (5 mm in diameter). Cyclic voltammetry was conducted with an Autolab potentiostat (PGSTAT128N) in a three-electrode electrochemical cell using saturated calomel electrode (SCE) as the reference electrode, a Pt mesh as the counter electrode, and the sample modified glassy carbon electrode as the working electrode. A 1.0 M KOH solution was used as the electrolyte, which was saturated with oxygen by bubbling O₂ prior to the start of each experiment. The flow of O₂ was maintained at a constant rate over the electrolyte during the recording of CV in order to ensure its continued O₂ saturation. CV profiles were recorded at a scan rate of 5 mV s⁻¹.

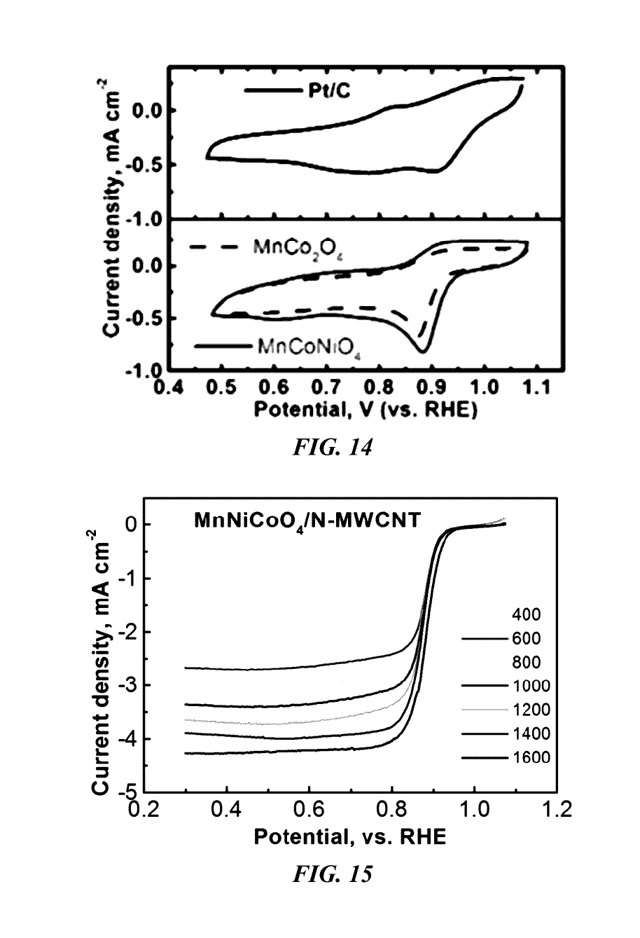

The electrocatalytic activity of the MnNiCoO₄/N-MWCNT catalyst for the oxygen reduction reaction was characterized by cyclic voltammetry (CV) in 1 M KOH on a glassy carbon electrode and compared with the MnCo₂O₄/N-MWCNT and Pt/C catalysts (FIG. 14). The oxygen reduction reaction onset potential and peak potential of the MnNiCoO₄/N-MWCNT catalyst are ˜0.95 and ˜0.88 V versus the reversible hydrogen electrode (RHE), respectively, which are ˜20 mV more negative than that of Pt/C catalyst, but ˜10 mV more positive than that of the MnCo₂O₄/N-MWCNT catalyst. Mn substitution in Co₃O₄/graphene hybrid catalyst to give MnCo₂O₄/graphene can enhance the oxygen reduction reaction activity. The MnNiCoO₄ catalyst presented here further improves the oxygen reduction reaction activity compared to MnCo₂O₄.

The catalyst-modified working electrode for rotating-disk electrode (RDE) measurements was prepared by the same method as for CV. The working electrode was scanned cathodically at a rate of 5 mV s⁻¹ with varying rotating speed from 400 to 1600 rpm. Koutecky-Levich plots (J⁻¹ vs. ω^{-1/2}) were analyzed with various electrode potentials. The slopes of their best linear fit lines were used to calculate the number of electrons transferred (n) on the basis of the Koutecky-Levich equations:

$$\frac{1}{J} = \frac{1}{B {ω}^{1 / 2 }} + \frac{1}{{J}_{K }}$$

$$B = 0.62 {nFC}_{0} {D}_{0}^{2 / 3} {v}^{- 1 / 6}$$

$${J}_{K} = {nFkC}_{0}$$

where J is the measured current density, J_{K} is the kinetic current density, ω is the angular velocity, n is transferred electron number, F is the Faraday constant, C₀ is the bulk concentration of O₂, v is the kinematic viscosity of the electrolyte, and k is the electron-transfer rate constant.

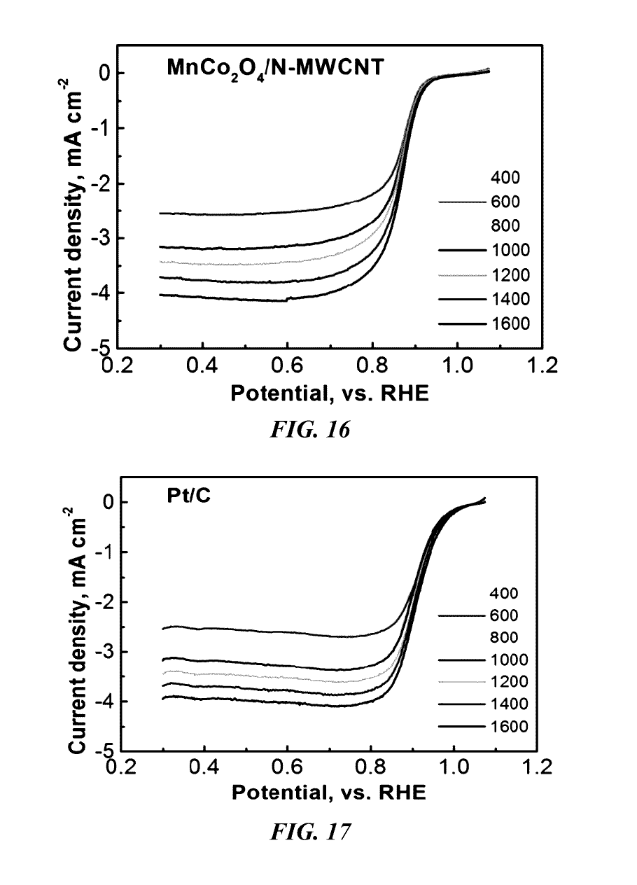

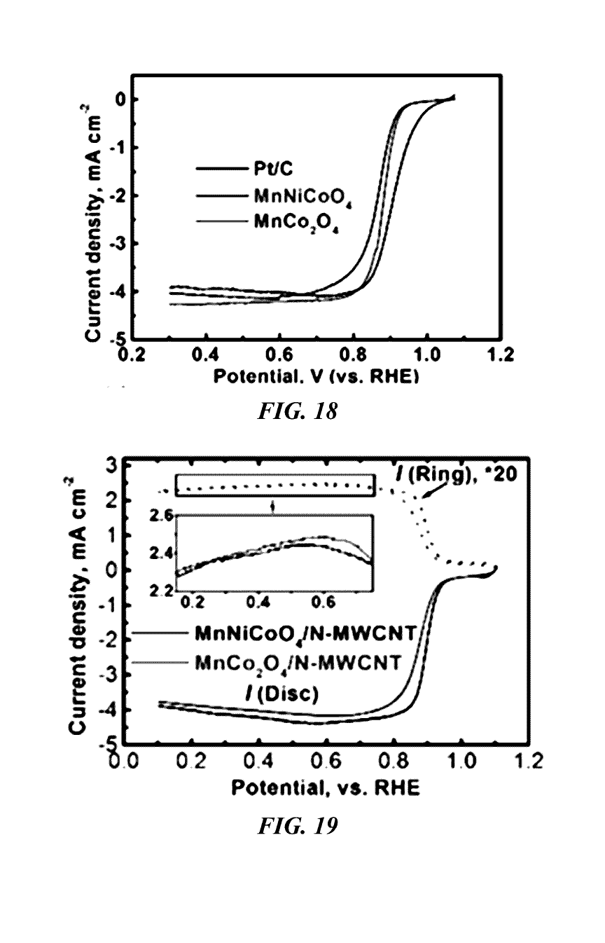

The detailed rotating-disk electrode profiles, e.g. linear sweep voltammograms at different rotating speeds, for the MnNiCoO₄N-MWCNT, MnCo₂O₄/N-MWCNT, and Pt/C catalysts in 1 M KOH solution saturated with oxygen are provided in FIG. 15, FIG. 16, and FIG. 17, respectively. The representative rotating disk electrode characteristics (at a rotating rate of 1600 rpm of the catalysts are compared in FIG. 18 (The MnNiCoO₄N-MWCNT catalyst shows superior oxygen reduction reaction performance than MnCo₂O₄/N-MWCNT in terms of disk current density and half-wave potential. In addition, the MnNiCoO₄/N-MWCNT shows half-wave potential similar to Pt/C (˜20 mV difference).

The oxygen reduction reaction pathway on the catalysts was studied with the rotating ring-disk electrode (RRDE). For the rotating ring-disk electrode measurements, catalyst inks and electrodes were prepared by the same method as those for the rotating disk electrode experiments. The disk electrode was scanned cathodically at a rate of 5 mV s⁻¹, and the ring potential was constant at 1.3 V vs. reversible hydrogen electrode. The % HO₂⁻ and the electron transfer number (n) were determined by the equations below:

$${HO}_{2}^{-} = 200 \frac{{I}_{r} / N}{{I}_{d} + {I}_{r} / N}$$

$$n = 4 \frac{{I}_{d}}{{I}_{d} + {I}_{r} / N}$$

where I_{d} is disk current, Iᵣ is ring current, and N is current collection efficiency of the Pt ring. N was determined to be 0.38 from the reduction of K₃Fe[CN]₆.

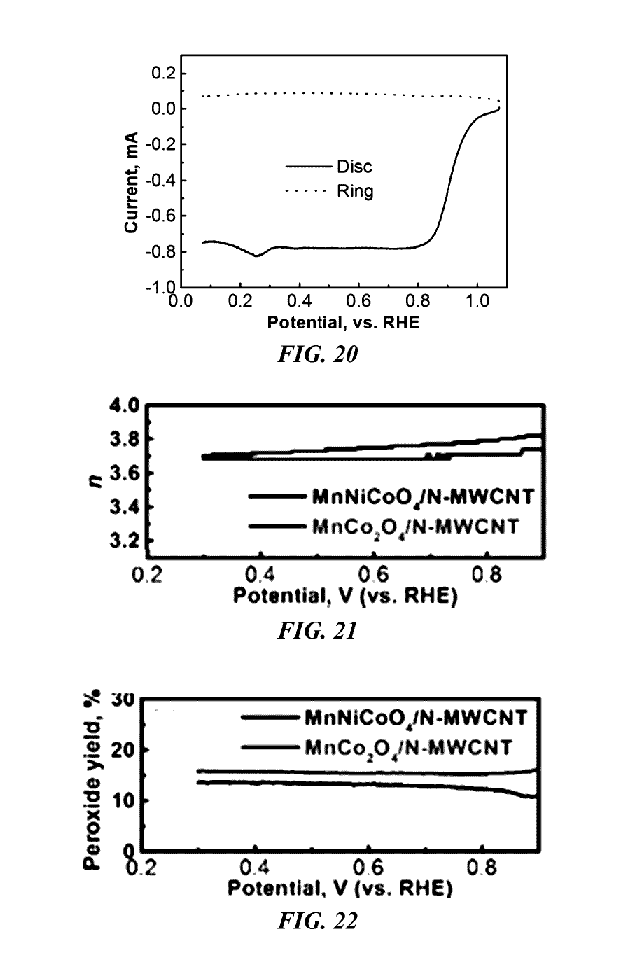

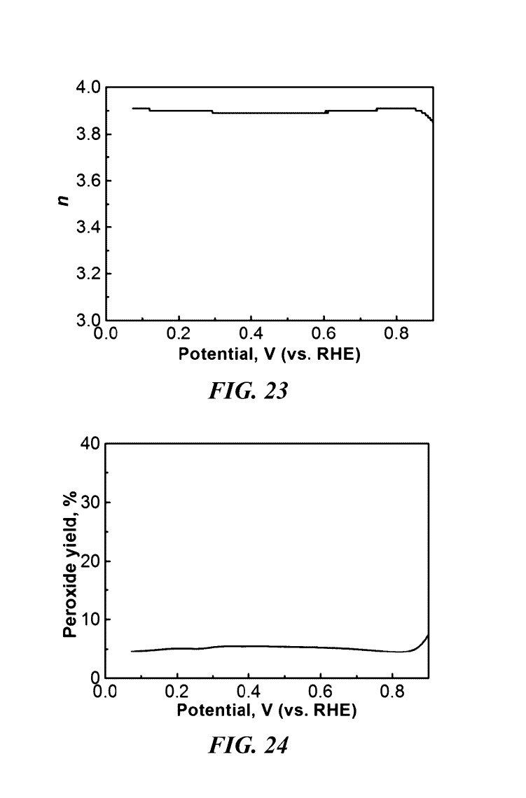

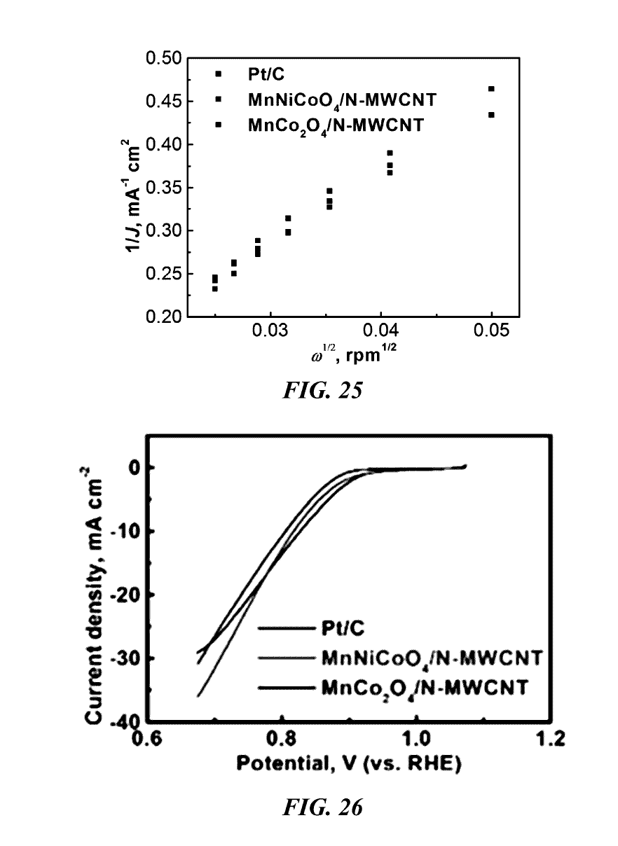

FIG. 19 displays the voltammetry profiles of the disk and ring recorded at 1600 rpm in 1 M KOH saturated with O₂ for the MnNiCoO₄N-MWCNT and MnCo₂O₄/N-MWCNT catalysts. MnNiCoO₄/N-MWCNT shows higher disk current (02 reduction) and a relatively smaller ring current (peroxide oxidation) than MnCo₂O₄/N-MWCNT (FIG. 19 inset). FIG. 20 displays the rotating ring-disk electrode (RRDE) voltammograms of the Pt/C catalyst in O₂-saturated 1 M KOH at 1600 rpm. The electron number for oxygen reduction (n) and the percentage of peroxide species relative to the total oxygen reduction products calculated from the rotating ring-disk electrode curves in FIG. 19 are provided in FIG. 21 and FIG. 22, respectively. The electron number for oxygen reduction (n) and the percentage of peroxide species relative to the total oxygen reduction products calculated from the rotating ring-disk electrode curves in FIG. 20 are provided in FIG. 23 and FIG. 24, respectively. The peroxide species is ˜14% over the measured potential range for the MnNiCoO₄/N-MWCNT catalyst (FIG. 22), which is lower than that found with MnCo₂O₄/N-MWCNT (˜16%; FIG. 22), but both are higher than that found with Pt/C (˜5%, FIG. 24). The average electron transfer number approaches 3.8 for the MnNiCoO₄/N-MWCNT catalyst (FIG. 21), which is close to that of the Pt/C catalyst (FIG. 23). In contrast, the electron transfer number is ˜3.7 for MnCo₂O₄/N-MWCNT within the potential frame of 0.3-0.9 V vs. reversible hydrogen electrode (FIG. 21). The above results indicate that the oxygen reduction reaction catalyzed by either MnNiCoO₄/N-MWCNT or MnCo₂O₄/N-MWCNT catalyst was mainly through the four electron pathway, which is in agreement with the rotating-disk electrode analysis results (FIG. 25).

In order to investigate the electrochemical performance of the catalysts under the conditions close to those present in alkaline fuel cells or metal-air batteries, experiments were performed with the samples prepared by loading the catalysts onto carbon paper. For measurements on carbon-fiber paper, the working electrode was prepared by the deposition of 0.5 mg of catalyst onto 1 cm² carbon-fiber paper (Toray paper 090, Fuel Cell Store) from the catalyst inks prepared as those for the CV, rotating-disk electrode, and rotating ring-disk electrode experiments. The cathodic linear sweep voltammetry profiles (for oxygen reduction reaction measurements) were recorded in a 1 M KOH solution with a constant flow of oxygen from 0 to −0.4 V (vs. saturated calomel electrode) at a scan rate of 5 mV s⁻¹. To obtain oxygen evolution reaction activities in 1 M KOH, the working electrode was scanned from 0 to 0.6 V (vs. saturated calomel electrode).

Cathodic polarization curves of the MnNiCoO₄N-MWCNT and MnCo₂O₄/N-MWCNT catalysts loaded on carbon paper are presented in FIG. 26 and compared with the commercial Pt/C catalyst loaded on carbon paper. The current density generated with MnNiCoO₄/N-MWCNT is higher than those with MnCo₂O₄/N-MWCNT, consistent with the CV, rotating-disk electrode, and rotating ring-disk electrode results. The current density of MnNiCoO₄/N-MWCNT is lower than that of the Pt/C catalyst at low overpotentials but exceeded that of the Pt/C at higher overpotentials.

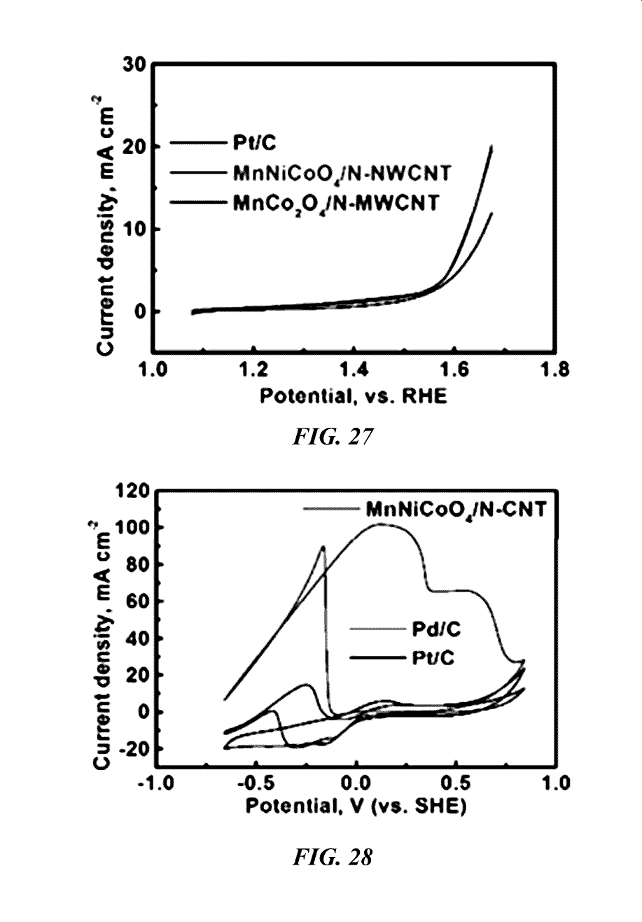

FIG. 27 compares the oxygen evolution reaction (OER) performances of the catalysts. The MnNiCoO₄/N-MWCNT and MnCo₂O₄/N-MWCNT catalysts shows similar oxygen evolution reaction performances. Both the MnNiCoO₄/N-MWCNT and MnCo₂O₄/N-MWCNT catalysts show higher oxygen evolution reaction catalytic activity than Pt/C, suggesting that the MnNiCoO₄/N-MWCNT and MnCo₂O₄/N-MWCNT composites are efficient bifunctional catalysts for oxygen reduction reaction and oxygen evolution reaction.

The present study reveals benefits of MnNiCoO₄/N-MWCNT relative to MnCo₂O₄N-MWCNT. For example, FIG. 14 reveals that the CV profile of MnNiCoO₄/N-MWCNT exhibits a larger loop compared to the CV profile of MnCo₂O₄N-MWCNT, suggesting that Ni doping can increase the electrochemically active surface area (or sites) in the catalyst. The increased activity of the active sites and higher electrochemically active surface area can enhance the catalytic activity of the MnNiCoO₄/N-MWCNT system.

The practical performance of the catalysts was also studied in a membraneless alkaline direct formate fuel cell (DFFC) with 5.0 cm² active area. Details of this cell can be found above. In this cell, Pd/C and MnCo₂O₄/N-MWCNT were used as the anode and cathode catalysts, respectively. An aqueous solution comprising HCOOK as the fuel and KOH as the supporting electrolyte was fed as an anolyte through a chamber between the anode and the cathode catalyst layers. The operation of the membraneless alkaline direct formate fuel cell was controlled with a fuel cell test station (850E, Scribner Associates Inc.). Since the cathode catalyst MnCo₂O₄N-MWCNT does not substantially catalyze the anode reaction, oxidation of the fuel will not take place at the cathode. In addition, the crossover of the cathode oxidant can be minimized because of the low solubility and diffusivity of O₂ in an aqueous alkaline solution. Therefore, the anion-exchange membrane used in the traditional alkaline direct liquid fuel cells can be excluded.

The practical performance of the MnNiCoO₄/N-MWCNT catalyst was studied with the membraneless alkaline direct formate fuel cell (DFFC), described in detail above, in which a selective cathode catalyst can be used to avoid the anode reaction at the cathode. The formate oxidation reaction activity of the MnNiCoO₄/N-MWCNT catalyst was tested and compared with that of the Pt/C catalyst (which is active for the formation oxidation reaction) in a 1 M HCOOK solution with 1 M KOH as supporting electrolyte. CV profiles are presented in FIG. 28. The MnNiCoO₄/N-MWCNT shows lower activity than the Pt/C for the formate oxidation reaction. The combination of high activity for the oxygen reduction reaction and inactivity for the formate oxidation reaction suggests that MnNiCoO₄/N-MWCNT can be a cathode catalyst for the membraneless alkaline direct formate fuel cells.

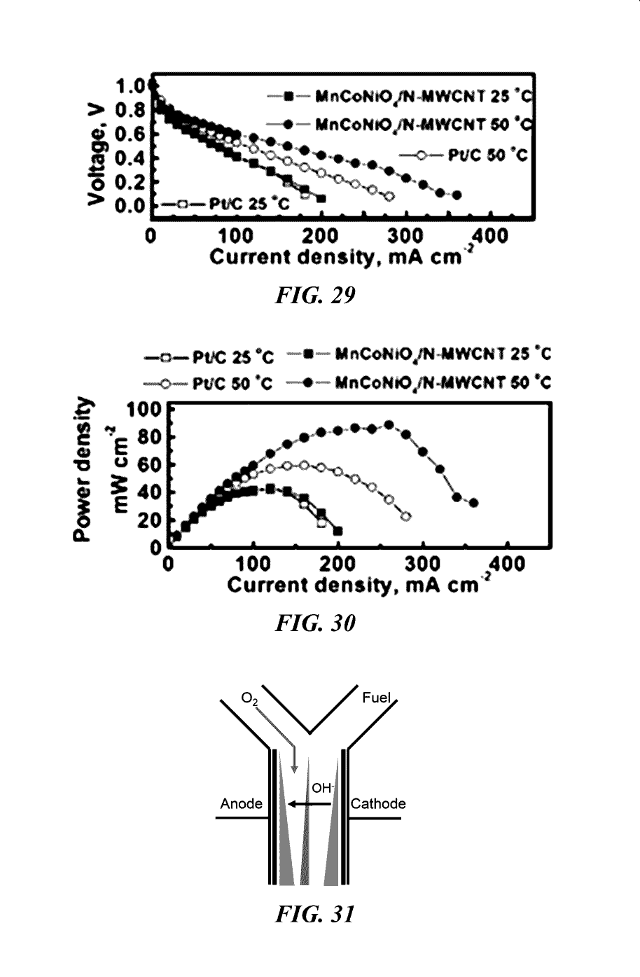

Performance of the membraneless direct formate fuel cells with Pd/C as the anode catalyst and MnNiCoO₄/N-MWCNT as the cathode catalyst was evaluated by operating a cell with 5 cm² active electrodes (areas of the anode and the cathode are substantially the same) and a 2 mm thick flow chamber. The details regarding the principles and configuration of the membraneless direct formate fuel cell are discussed above. For the single cell measurements, an anolyte solution containing 2.0 M HCOOK in 2.0 M KOH was pumped through the flow chamber at a flow rate of 0.5 mL min⁻¹. Oxygen was fed to the cathode at a flow rate of 100 mL min⁻¹ without back pressure. The Pd loading at the anode and the MnNiCoO₄/N-MWCNT or Pt/C loading at the cathode were both 1.0 mg cm⁻². Cell performances were tested at 25 and 50° C. FIG. 29 and FIG. 30 show the polarization curves and the corresponding power plots, respectively.

The open-circuit voltage (OCV) of the membraneless direct formate fuel cell is ca. 1.05 V, which is higher than those of other direct liquid fuel cells (DLFCs), such as direct methanol fuel cell (DMFC), direct ethanol fuel cells (DEFC), and direct formic acid fuel cell (DFAFC) (Zhao X et al. Energy Environ. Sci., 2011, 4, 2736-2753; Li X L and Faghri A. J. Power Sources. 2013, 226, 223-240; Kamarudin M Z F et al. Int. J Hydrogen Energy, 2013, 38, 9438-9453; Ji X L et al. Nat. Chem., 2010, 2, 286-293; Yu X and Pickup P G. J. Power Sources. 2008, 182, 124-132). Under the testing conditions with low catalyst loading demonstrated in this study at 50° C. the specific power of the membraneless direct formate fuel cell is ca. 90 mW cm⁻² and the specific current at 0.6 V is ca. 120 mA cm⁻². This performance is comparable to the alkaline direct liquid fuel cells with alkaline anion-exchange membranes and with a high-loading Pt cathode catalyst (Bianchini C and Shen P K, Chem. Rev., 2009, 109, 4183-4206: Yu E H et al. Energies. 2010, 3, 1499-1528: Jiang J H and Wieckowski A. Electrochem. Commun., 2012, 18, 41-43). The cell with the MnNiCoO₄N-MWCNT cathode outputs higher power than that with the Pt/C cathode, especially at elevated temperatures (50° C.). As seen in FIG. 28, the Pt/C catalyst shows slight catalytic activity for the formate oxidation reaction, which may induce a certain level of mixed current during operation of the membraneless direct formate fuel cells. On the other hand, MnNiCoO₄/N-MWCNT does not show any positive current in the voltammetry profile within the potential domain of −0.7 V-0 V vs. standard hydrogen electrode (SHE) (direct formate fuel cell operation potential frame), indicating more selectivity for the MnNiCoO₄/N-MWCNT relative to Pt/C for the operation of the membraneless direct formate fuel cells.

A nanocomposite catalyst comprising MnNiCoO₄ nanoparticles on nitrogen-doped multi-wall carbon nanotubes (N-MWCNT) for oxygen reduction reaction and oxygen evolution reaction was discussed. The MnNiCoO₄/N-MWCNT catalyst exhibits bifunctional catalytic activity for the oxygen reduction reaction and oxygen evolution reaction, which can be useful for rechargeable alkaline metal-air batteries. The MnNiCoO₄/N-MWCNT catalyst exhibits catalytic selectivity with oxygen reduction reaction activity but formate oxidation reaction inactivity in membraneless direct formate fuel cells, demonstrating superiority to Pt/C cathode catalysts.

### Example 3

Discussed herein is a scalable, membraneless alkaline direct liquid fuel cell (DLFC) platform, employing non-platinum cathode catalysts that exhibit high activity selectively for the oxygen reduction reaction without any substantial activity for the anode fuel oxidation reaction. Management of the catalyst selectivity, can allow operation of the direct liquid fuel cells wherein the anode fuel can freely enter the cathode. This catalyst-selective strategy can not only avoid the use of cation or anion-exchange membranes, but can also overcome the scalability limitations of conventional laminar-flow-based membraneless direct liquid fuel cells. With proper management of the catalyst selectivity in the cell, a variety of renewable organic liquids can be used as anode fuels. The membraneless direct liquid fuel cells can offer high power density, which can enable the development of small, safe, inexpensive portable power systems as well as large-scale energy generation systems for transportation and stationary applications.

The need and desire for sustainable energy resources has driven the development of direct liquid fuel cells (DLFCs). Currently, concerns associated with the low-temperature direct liquid fuel cells based on proton exchange membranes (PEM) can be due to the sluggish kinetics of electrode reactions (e.g., due to reliance on the high-loading, expensive Pt-based cathode catalysts) and the high cost of Nafion® membranes (Yu X W and Ye S Y. J Power Sources, 2007, 172, 145-154: Yu X W and Ye S Y. J Power Sources, 2007, 172, 133-144; Hiesgen R et al. Fuel Cells, 2006, 6, 425-431; Ralph T R and Hogarth M P. Platin Met Rev, 2002, 46, 117-135). One approach to enhance the electrode reaction kinetics is to operate the direct liquid fuel cells in alkaline media (Varcoe J R and Slade R C T. Fuel Cells, 2005, 5, 187-200: Zeng R et a. Energ Environ Sci., 2011, 4, 4925-4928). However, a practically viable alkaline anion exchange membrane (AEM) has yet to be developed to meet the demand of the direct liquid fuel cells.

Development of membraneless direct liquid fuel cells can avoid the use of anion exchange membranes. However, the membraneless fuel cells are currently all theoretically based on a micro-flow phenomenon (FIG. 31), which can be built only to millimeter-scale sizes, which can limit their practical application (Shaegh S A M et al. Int J Hydrogen Energy, 2011, 36, 5675-5694). As a result, the development of practically viable direct liquid fuel cells is currently facing a sequence of challenges due to the (1) high cost of the cell components (proton exchange membrane-based direct liquid fuel cells), (2) lack of reliable and viable anion exchange membranes (alkaline direct liquid fuel cells), or (3) limitation in the scalability (laminar-flow membraneless direct liquid fuel cells). Described herein are scalable membraneless alkaline direct liquid fuel cell platforms with a catalyst-selective strategy that can break through all the above “bottle-neck” obstacles of the direct liquid fuel cell technology.

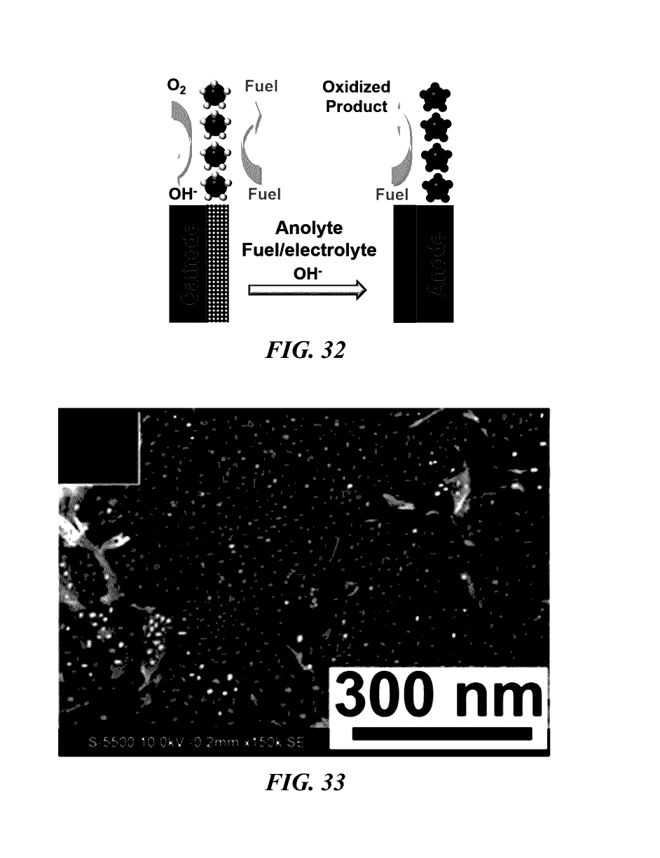

Generally in an alkaline direct liquid fuel cell, use of an anion exchange membrane provides a conductive path for the OH⁻ ion migration and prevents the crossover of the liquid fuel and the oxidants, since the commonly used cathode catalysts (e.g., Pt) can also catalyze the anode oxidation reaction. The proposed catalyst-selective strategy is illustrated in FIG. 32. By employing a non-Pt cathode catalyst with high activity for the oxygen reduction reaction, but without any substantial activity for the fuel oxidation reaction (FOR), the direct liquid fuel cells can allow the anode fuel to freely enter the cathode, eliminating the need for an anion exchange membrane in the cell. On the other hand, as a general scenario, the solubility and diffusivity of oxygen is fairly low in aqueous alkaline solutions (Gubbins K E et al. J Electrochem Soc., 1965, 112, 469-471; Davis R E et al. Electrochim Acta, 1967, 12, 287-297), which can minimize the crossover of the cathode oxidant. In addition, the ionic path between the anode and the cathode can be addressed by the addition of a supporting electrolyte (e.g., KOH) to the anode fuel (to form an anolyte), which can sustain the conductivity of the OH⁻ ions. With proper management of the catalyst selectivity in the cell, a variety of renewable organic liquids can be used as anode fuels. In addition, the catalyst-selective strategy can allow operation of the membraneless direct liquid fuel cells without any manipulation of the non-mixture laminar-flow of the fuel and the air, which can enable the development of power-generation devices in flexible configurations without dimensional limitations.

Management of the anode and cathode catalysts in the direct liquid fuel cells can play a role in the described systems, as can the selectivity of the cathode catalyst. Herein, the proposed platform employs a PtRu/C (platinum-ruthenium alloy on carbon support) anode catalyst is examine with four renewable organic liquids used as anode fuels, including two alcohols (methanol and ethanol) and two poly-alcohols (ethylene glycol and glycerol). Half-cell reactions and the physico-chemical properties of these organic liquids relevant to the fuel cell operation are provided in Table 1. These hydrogen-rich alcohols can provide high energy density direct liquid fuel cell systems with respect to their capacity and ability of multiple-electron charge transfer (Tiwari J N et al. Nano Energy, 2013, 2, 553-578; Zhou Y and Xu Q J. Adv Mater Res-Switz., 2014, 860-863, 797-800; Serov A and Kwak C. Appl Catal B-Environ., 2010, 97, 1-12; Han X T et al. Int J Hydrogen Energ., 2014, 39, 19767-19779; Zhang Z Y et al. Appl Catal B-Environ., 2012, 119, 40-48).

TABLE 1
Half-cell reactions and characteristics of renewable fuels for the development of
membraneless alkaline direct liquid fuel cells.

| | | Number | | Specific | Boiling |
|---|---|---|---|---|---|
| Fuel | Half-cell reaction | of e⁻ (n) | E⁰ (V) | energy density | point |
| CH₃OH | CH₃OH + 6OH⁻ → 5H₂O + CO₂ + 6e⁻ | 6 | −0.81 | 6.07 kWh Kg⁻¹ | 65° C. |
| CH₃CH₂OH | CH₃CH₂OH + 12OH⁻ → 9H₂O + 2CO₂ + 12e⁻ | 12 | −0.74 | 8.03 kWh Kg⁻¹ | 78° C. |
| C₂H₆O₂ | C₂H₆O₂ + 10OH⁻ → 8H₂O + 2CO₂ + 10e⁻ | 10 | −0.82 | 5.27 kWh Kg⁻¹ | 197° C. |
| C₃H₈O₃ | C₃H₈O₃ + 14OH⁻ → 11H₂O + 3CO₂ + 14e⁻ | 14 | −0.85 | 5.09 kWh Kg⁻¹ | 290° C. |

A non-Pt cathode catalyst MnNiCoO₄/N-MWCNT (MnNiCoO₄ nanoparticles on nitrogen-doped multi-wall carbon nanotubes), discussed above, is used to demonstrate the membraneless alkaline direct methanol fuel cell (DMFC) and direct ethanol fuel cell (DEFC). Owing to the chemical interaction between the N-doped carbon surface and the spinel oxide nanoparticles, this catalyst can exhibit an excellent oxygen reduction reaction activity that is comparable to that of Pt in an alkaline medium (as discussed above), but is theoretically not expected to catalyze the oxidation reactions of the small-molecule organic liquids. Since the cathode catalyst can play an important role in the systems discussed herein, an additional cathode catalyst comprising binary transition-metal oxide nanoparticles on nitrogen-doped graphene (NiCo₂O₄/N-graphene) was developed for the study of the membraneless direct ethylene glycol fuel cell (DEGFC) and direct glycerol fuel cell (DGFC).

The NiCo₂O₄/N-graphene catalyst can be synthesized through an impregnation-hydrothermal process. The graphene material was synthesized from natural graphite by a modified Hummers method (W. S. Hummers and R. E. Offeman, J. Am. Chem. Soc., 1958, 80, 1339) with the following procedure. Graphite powder (2.0 g, SP-1, Bay Carbon, Mich.) and 1.0 g of NaNO₃ (Aldrich, >99%) were mixed and dissolved/dispersed into 96 mL of concentrated H₂SO₄ (Fisher Scientific, 98%) in an ice bath. Under vigorous stirring, 6.0 g KMnO₄ (Fisher Scientific, 99.6%) was gradually added to the mixture. The temperature of the mixture was maintained below 20° C. with an ice bath. After removing the ice bath, the mixture was stirred at 35° C. in a silicon oil bath for 18 h. As the reaction progressed, the mixture became pasty with a brownish color. Successively, 150 mL of deionized water was slowly added to the above pasty mixture. Addition of water into the concentrated H₂SO₄ medium released a large amount of heat, so an ice bath was used to maintain the temperature below 50° C. After further dilution with 500-600 mL of water, 5.0 mL of 30% H₂O₂ (Fisher Scientific) was added to the mixture. The color of the diluted solution changed to brilliant yellow, and bubbles formed. After continuous stirring for 2 h, the mixture was filtered and washed with a 10% HCl aqueous solution (˜1000 mL, 250 mL×4 times, Fisher Scientific), and copious deionized water to remove other ions, until the pH reached 4-5. The resulting graphene powder was dried at 60-70° C. under vacuum for 24 h.

The synthesized graphene powder was pretreated by refluxing the material (0.2 g) in 50 mL of nitric acid at 80° C. for 4 h. Then, the mixture was the cooled to room temperature and diluted with 100 mL of de-ionized (DI) water. The resulting solid was collected by centrifugation, washed with deionized water several times, and dried at 50° C. under vacuum.

For a typical catalyst synthesis herein, 1.45 mL of 0.4 M Ni(OAc)₂ and 1.94 mL of 0.6 M Co(OAc)₂ aqueous solutions (molar ratio of Ni to Co of 1:2) were added to a 50 mL of ethanol solution with 0.2 g graphene suspension, followed by the addition of 5.0 mL of NH₄OH at room temperature, which was used to mediate the nucleation of the metal species and provide a source for nitrogen doping. The reaction was kept at 80° C. with stirring for 24 h. The reaction mixture was then transferred to an 80 mL autoclave for hydrothermal reaction at 150° C. for 3 h to obtain N-doping and crystallization of the metal oxide nanoparticles on graphene. The resulting product was collected by centrifugation and washed with ethanol and water. The NiCo₂O₄/N-graphene composite product was ˜340 mg after drying (˜41.2 wt. % NiCo₂₀₄ on graphene).

Morphological characterization of the catalyst was carried out with a Hitachi S-5500 scanning transmission electron microscope (STEM). The elemental determination results were obtained with an energy-dispersive spectrometer (EDS) attached to the Hitachi S-5500 STEM. The XRD data were collected on a Rigaku D/MAX-RC X-ray diffractometer equipped with Cu Kα radiation between 10° and 80° in a step of 0.02°.

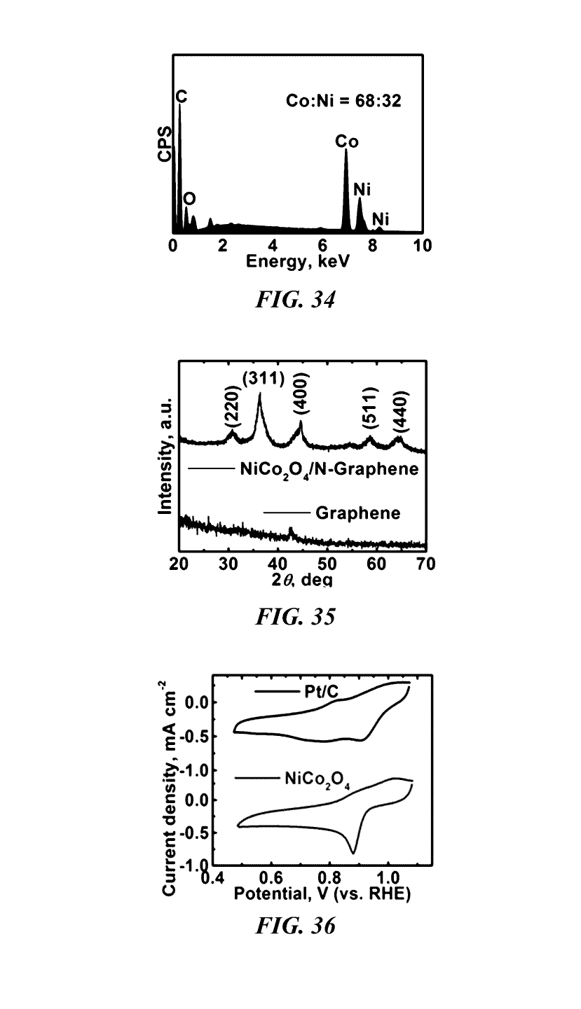

Scanning transmission electron microscopy (STEM) image of the catalyst displayed in FIG. 33 indicates the formation of the NiCo₂O₄ nanocrystals on the graphene support. Energy dispersive spectroscopy (EDS) analysis (FIG. 34) reveals that the molar ratio of Co:Ni in the catalyst is 68:32, which is close to the ratio in the Co and Ni precursors used in the synthesis (Co:Ni=2:1). X-ray diffraction (XRD) pattern of the NiCo₂O₄/N-graphene catalyst (FIG. 35) shows that the synthesized nanocrystals are single-phase with the cubic spinel structure.

The electrocatalytic activity of the NiCo₂O₄/N-graphene catalyst for oxygen reduction reaction was first characterized by cyclic voltammetry (CV). The powder catalyst (10 mg) was dispersed into a solution comprising of 800 μL of deionized water, 200 μL of isopropanol (IPA), and 18 μL of Nafion solution (15 wt. %) by sonication for 10 min to form a homogeneous ink. Then, 5 μL of the catalyst ink was loaded onto a glassy carbon electrode of 5 mm in diameter. Cyclic voltammetry was conducted with an Autolab potentiostat (PGSTAT128N) in a three-electrode electrochemical cell with a saturated calomel electrode (SCE) as the reference electrode, a Pt mesh as the counter electrode, and the sample modified glassy carbon electrode as the working electrode. A 1.0 M KOH solution was used as the electrolyte, which was saturated with oxygen by bubbling O₂ prior to the start of each experiment. The flow of O₂ was maintained at a constant rate over the electrolyte during the recording of CV in order to ensure its continued O₂ saturation. CV profiles were recorded at a scan rate of 5 mV s⁻¹.

The electrocatalytic activity of the NiCo₂O₄/N-graphene catalyst for oxygen reduction reaction was first characterized by cyclic voltammetry (CV) in 1.0 M KOH on a glassy carbon electrode and compared with that of Pt/C catalyst (FIG. 36). The oxygen reduction reaction onset potential and peak potential of the NiCo₂O₄/N-graphene catalyst are, respectively, 0.94 and ˜0.89 V vs. the reversible hydrogen electrode (RHE), which are ˜20 mV more negative than that of Pt/C catalyst.

The catalyst-modified working electrode was prepared by the same method as for CV. Linear sweep voltage (LSV) experiments were also conducted with the Autolab potentiostat (PGSTAT128N) in a three-electrode electrochemical cell with a saturated calomel electrode (SCE) as the reference electrode, a Pt mesh as the counter electrode, and the sample modified glassy carbon electrode as the working electrode. The working electrode was scanned cathodically at a rate of 5 mV s⁻¹ with varying rotating speed from 400 to 1600 rpm controlled by a rotator (Pine Research Instrumentation).

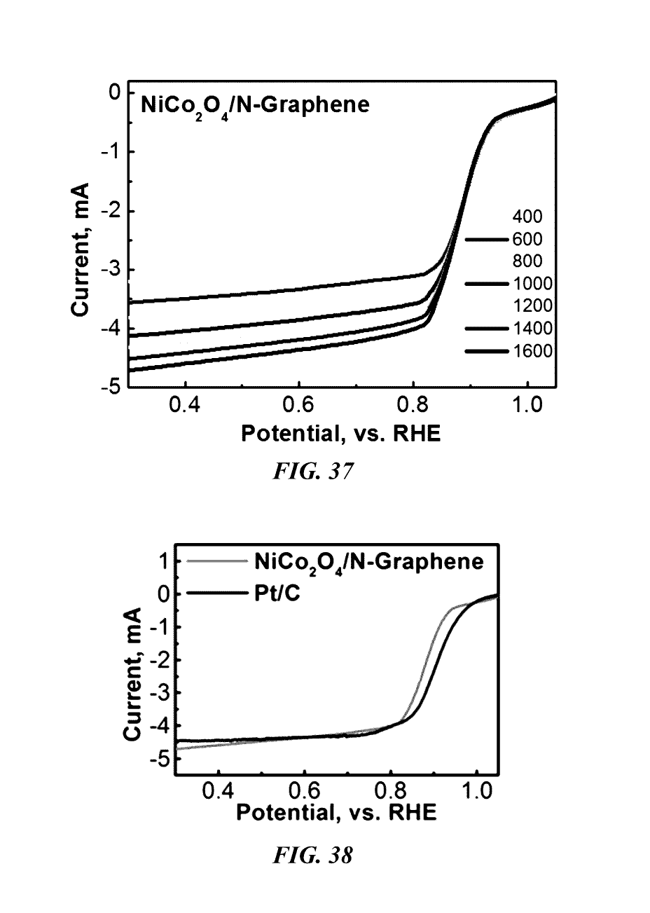

The detailed rotating disc electrode profiles of the catalysts in 1.0 M KOH solution saturated with oxygen at different rotating speeds are provided in FIG. 37. The representative rotating disc electrode (RDE) characteristics (linear sweep voltammograms at a rotating rate of 1600 rpm) of the catalysts in 1.0 M KOH solution saturated with oxygen are compared in FIG. 38; The NiCo₂O₄/N-graphene catalyst shows half-wave potential similar to Pt/C (only ˜20 mV difference).

The oxygen reduction reaction pathway on the catalyst was studied with the rotating ring-disk electrode (RRDE). For the rotating ring-disk electrode measurements, catalyst inks and electrodes were prepared by the same method as those for the RDE experiments. The disc electrode was scanned cathodically at a rate of 5 mV s⁻¹, and the ring potential was constant at 1.3 V vs. reversible hydrogen electrode (RHE). The % HO₂⁻ and the electron-transfer number (n) were determined as described above.

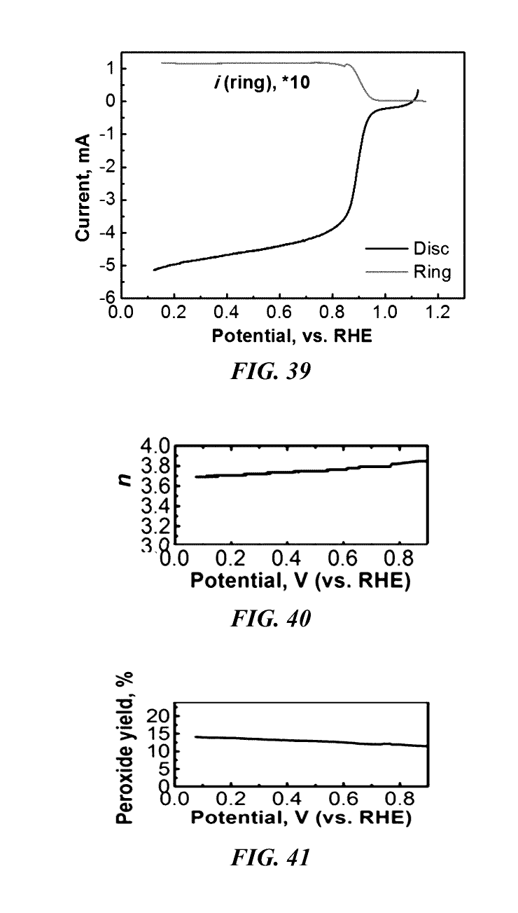

The oxygen reduction reaction pathway on the catalyst was studied with the rotating ring-disk electrode (RRDE). FIG. 39 displays the voltammetry profiles of the disk and ring recorded at 1600 rpm in 1.0 M KOH saturated with O₂ for the NiCo₂O₄/N-graphene catalyst. The electron number for oxygen reduction (n) and the percentage of peroxide species relative to the total oxygen reduction products calculated from the rotating ring-disk electrode curves in FIG. 39 are provided in FIG. 40 and FIG. 41, respectively. The peroxide species is 11-14% over the measured potential range for the NiCo₂O₄/N-graphene catalyst. The average electron-transfer number approaches 3.8 for the NiCo₂O₄/N-graphene catalyst, very close to that of Pt/C catalyst (Spendelow J S and Wieckowski A. Phys Chem Chem Phys, 2007, 9, 2654-2675: Yeager E. Electrochim Acta, 1984, 29, 1527-1537). The above results indicate that the oxygen reduction reaction catalyzed by the NiCo₂O₄/N-graphene catalyst was mainly through the four-electron pathway.

Catalysts employed for the fuel oxidation reaction studies include 40% PtRu/C (40 wt. % Pt—Ru with Pt:Ru=1:1 on Vulcan® XC-72, E-TEK) and the synthesized NiCo₂O₄/N-graphene catalyst. The catalyst was dispersed in a mixture of deionized water and a certain volume of Nafion solution (5%, DuPont®) by sonication for 10 min. The mass ratio of net Nafion to the catalyst was 1:4 (mass ratio) in all cases. The resulting ink was deposited onto a carbon fiber paper (Toray HP-60) and dried in air for 1 h at room temperature.

Cyclic voltammetry experiments were conducted in a conventional three-electrode glass cell with a Pt mesh counter electrode. Hg/HgO was used as a reference electrode. The working electrodes were prepared by depositing 1.6 mg of the catalyst (including carbon support and Nafion) onto a 1.0 cm² area of a strip of carbon fiber paper. The electrochemical data were collected with a potentiostat (VoltaLab PGZ 402, Radiometer Analytical) at ambient temperature.

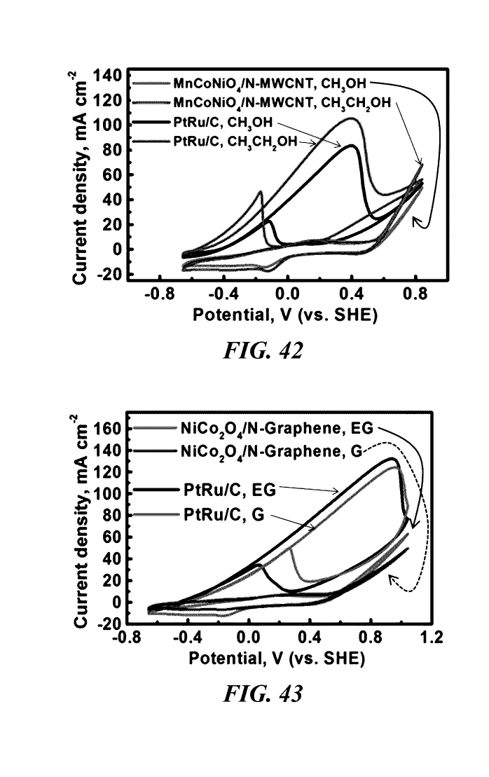

FIG. 42 and FIG. 43 demonstrate the fuel oxidation reaction activity of the PtRu/C catalyst and the fuel oxidation reaction inactivity of the MnNiCoO₄/N-MWCNT and the NiCo₂O₄N-graphene catalysts. On the PtRu/C electrode, the oxidation current of methanol, ethanol, ethylene glycol, or glycerol increases almost lineally in the potential range of −0.6 to 0.1 V (vs. SHE), which is a matched potential domain for the alkaline fuel cell operation. However, the MnNiCoO₄/N-MWCNT (FIG. 42) and the NiCo₂O₄N-graphene (FIG. 43) do not provide any substantial catalytic activity for the oxidation of the above organic liquid fuels. The fuel oxidation reaction currents on either the MnNiCoO₄/N-MWCNT or the NiCo₂O₄/N-graphene electrode is almost negligible in contrast to that generated on the PtRu/C electrode.

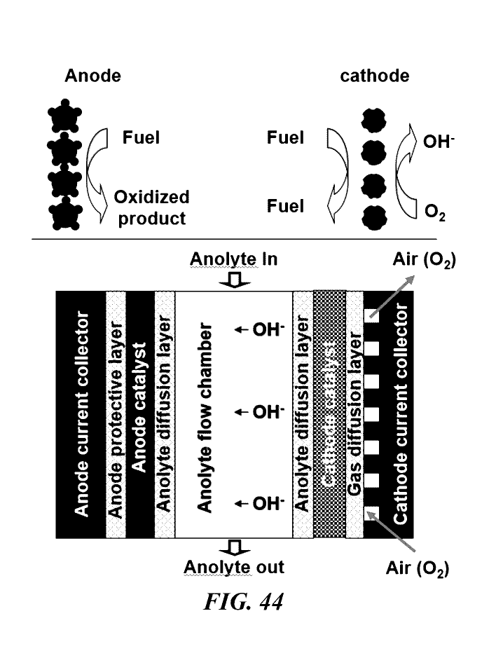

According to the above catalytic selectivity, four membraneless alkaline direct liquid fuel cell systems (direct methanol fuel cell, direct ethanol fuel cell, direct ethylene glycol fuel cell, and direct glycerol fuel cell) were developed without employing an anion exchange membrane. The cell performances were tested with an in-house designed membraneless fuel cell (as illustrated in FIG. 44) in which an aqueous solution comprising either methanol, ethanol, ethylene glycol, or glycerol as fuel and KOH as a supporting electrolyte was fed as an anolyte through a chamber between the anode and the cathode catalyst layers.

For the fuel cell performance tests, methanol, ethanol, ethylene glycol, and glycerol from Fisher Scientific® were added into aqueous KOH solution to form the aqueous alkaline anolytes with 5.0 M fuels (methanol, ethanol, ethylene glycol, or glycerol) and 2.0 M KOH. The electrodes for fuel cell performance tests were prepared the same way as described above. The catalysts (PtRu/C, MnCoNiO₄/N-MWCNT, or NiCo₂O₄ON-graphene) were dispersed in a mixture of deionized water and a certain volume of Nafion solution (5%, DuPont®) by sonication for 10 min. The mass ratio of net Nafion to the catalyst was 1:4 (mass ratio) in all cases. The resulting ink was deposited onto a carbon fiber paper (Toray HP-60) and dried in air for 1 h at room temperature. The catalyst loading at both the anode and the cathode were 2.6 mg cm⁻² (including PtRu-alloy, MnCoNiO₄, or NiCo₂O₄, not including the carbon support, MWCNT, or graphene) in all cases.

A membraneless alkaline direct liquid fuel cell (as schematized in FIG. 44) with 5.0 cm² active area (areas of the anode and the cathode were substantially identical) and a 2 mm thick flow chamber was used for cell performance tests. The operation of the membraneless alkaline direct liquid fuel cells were controlled with a fuel cell test station (850E, Scribner Associates Inc.). For the single-cell measurements, anolyte solutions were pumped through the flow chamber at a flow rate of 1.0 mL min⁻¹. Oxygen was fed to the cathode at a flow rate of 100 mL min⁻¹ without back pressure.

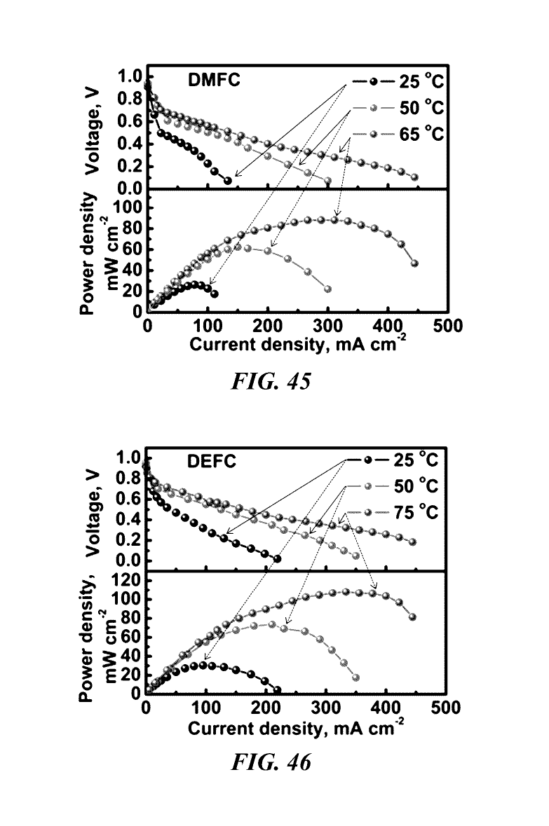

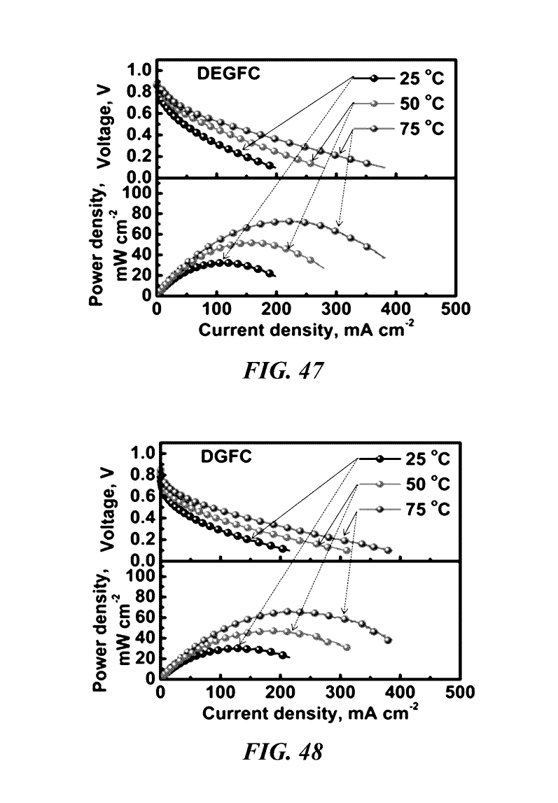

FIG. 45, FIG. 46, FIG. 47, and FIG. 48 shows the polarization curves and the corresponding power plots of the membraneless alkaline direct methanol liquid fuel cell, membraneless alkaline direct ethanol liquid fuel cell, membraneless alkaline direct ethylene glycol liquid fuel cell, and membraneless alkaline direct glycerol liquid fuel cell, respectively, under the specifications and operation conditions described in Table 2. Certain cell performance metrics of the four fuel cell systems are also summarized in Table 2.

TABLE 2
Specifications and performances of the membraneless alkaline direct methanol
fuel cell (DMFC), direct ethanol fuel cell (DFFC), direct ethylene glycol fuel cell (DEGFC),
and direct glycerol fuel cell (DGFC) systems.

| Membraneless | Fuel/ | Cathode | Anode | Maximum power | | Current density at |
|---|---|---|---|---|---|---|
| fuel cell system | anolyte | catalyst | catalyst | density, mW cm⁻² | | 0.55 V, mA cm⁻² |
| DMFC | Methanol/ | MnCoNiO₄/ | PtRu/C | >90 at | (65° C.) | ~100 |
| | KOH | N-MWCNT | | | | |
| DEFC | Ethanol/ | MnCoNiO₄/ | PtRu/C | >100 | (at 75° C.) | ~150 |
| | KOH | N-MWCNT | | | | |
| DEGFC | Ethylene glycol/ | NiCo₂O₄/N- | PtRu/C | >80 | (at 75° C.) | ~100 |
| | KOH | graphene | | | | |
| DGFC | Glycol/ | NiCo₂O₄/N- | PtRu/C | >70 | (at 75° C.) | ~70 |
| | KOH | graphene | | | | |

The above performance data obtained with the membraneless alkaline direct liquid fuel cells with the non-Pt cathode catalysts are superior to those of traditional direct methanol fuel cells, direct ethanol fuel cells, direct ethylene glycol fuel cells, and direct glycerol fuel cells with the H⁺-proton exchange membranes or the OH⁻-anion exchange membranes, which are operated with a high-loading Pt cathode catalyst (Bianchini C et al. Chem Rev., 2009, 109, 4183-4206; Yu E H et al. Energies, 2010, 3, 1499-1528; An L. et al. Int J Hydrogen Energy, 2013, 38, 10602-10606; Zhang Z Y et al. Int J Hydrogen Energy, 2012, 37, 9393-9401). In the traditional direct liquid fuel cells, even with a H⁺-proton exchange membrane or a OH⁻-anion exchange membrane, the anode fuel (especially at high concentrations) on the anodic side has the tendency to diffuse through the membrane to the cathode, where it is rapidly oxidized on the cathode catalyst (e.g., Pt). Such a fuel cross-over behavior, which can negatively affect cell performance (due to a mixed potentials at the cathode and the loss of the fuel reaction at the anode), can be substantially eliminated by the proposed catalyst-selective strategy. Therefore, the membraneless direct liquid fuel cells demonstrated herein can show enhanced performance in contrast to those traditional membrane-based direct liquid fuel cells.

High-power direct liquid fuel cells can be developed with inexpensive, renewable organic liquid fuels and non-platinum cathode catalysts without the need for the expensive or difficult-to-develop ion-change membranes and without any substantial fuel crossover concerns. Furthermore, based on its working principle, the catalyst-selective strategy can allow for the development of the direct liquid fuel cells without dimensional limitations in flexible configurations. With these features, the membraneless alkaline direct liquid fuel cells operated under the catalyst-selective strategy can overcome certain limitations existing with the conventional proton exchange membrane-based direct liquid fuel cells, anion exchange membrane-based direct liquid fuel cells, and laminar-flow membraneless direct liquid fuel cells.

One potential issue for the operation of the membraneless alkaline direct liquid fuel cells is the poisoning of the electrolyte by CO₂. In addition to the CO₂ from ambient air similar to the common issue associated with the traditional alkaline fuel cells, the oxidation of the liquid anode fuels introduces an additional source of electrolyte carbonation (CO₂ generated in situ). The CO₂ issue from ambient air at the cathode can be easily mitigated by purifying the air with a “CO₂-scrubber.” One effective way to circumvent the problem of the in-situ generated CO₂ at the anode is to replenish the spent alkaline electrolyte on a regular maintenance schedule. Our on-going and future work include the use of a “CO₂-absorption layer” at the anode side to prevent the fuel oxidation product (CO₂) from getting into the main stream of the anolyte. In addition, non-precious metal-based anode catalysts can replace the conventional PtRu/C used herein, which can further reduce the overall cost of the membraneless direct liquid fuel cells.

The proposed platform discussed herein was demonstrated with the direct methanol fuel cell, direct ethanol fuel cell, direct ethylene glycol fuel cell, and direct glycerol fuel cell systems. The results herein suggests that the catalyst-selective direct liquid fuel cells can be expanded to a broad range of energy-generation systems with a vast range of inexpensive, non-hazardous, renewable fuels through a proper exploration of the anode/cathode catalysts and logical managements of the catalyst selectivity. In this regard, the “catalyst-selective strategy” can provide an approach to develop membraneless direct liquid fuel cells, which can impact next-generation clean energy conversion/generation technologies. The membraneless direct liquid fuel cell systems can enable the development of small, safe, low-cost portable power systems as well as large-scale energy generation systems for electric vehicle and stationary applications.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

What is claimed is:

1. A membraneless direct liquid fuel cell, comprising:
an anode comprising an anode catalyst;
a cathode comprising a cathode catalyst;
an aqueous solution comprising a fuel, an electrolyte, and water;
an oxygen source in electrochemical contact with the cathode catalyst;
wherein the anode catalyst and the cathode catalyst are in electrochemical contact with the aqueous solution;
wherein the anode catalyst is catalytically active for the oxidation of the fuel;
wherein the cathode catalyst is catalytically active for the reduction of oxygen and is substantially catalytically inactive for the oxidation of the fuel; and
wherein the fuel comprises an organic liquid.

2. The membraneless direct liquid fuel cell of claim 1, wherein the organic liquid comprises an alcohol, a polyol, or a combination thereof.

3. The membraneless direct liquid fuel cell of claim 1, wherein the fuel is selected from the group consisting of methanol, ethanol, ethylene glycol, glycerol, and formate.

4. The membraneless direct liquid fuel cell of claim 1, wherein the oxygen source comprises air.

5. The membraneless direct liquid fuel cell of claim 1, wherein the pH of the aqueous solution is greater than 7.

6. The membraneless direct liquid fuel cell of claim 1, wherein the current density for the oxidation of the fuel on the anode catalyst is from 0 mA cm⁻² to 1000 mA cm⁻² in the potential range of −0.7 to 0.1 V as measured against a standard hydrogen electrode.

7. The membraneless direct liquid fuel cell of claim 1, wherein the current density for the oxidation of the fuel on the cathode catalyst is from 0 mA cm⁻² to 10 mA cm⁻² in the potential range of −0.7 to 0.1 V as measured against a standard hydrogen electrode.

8. The membraneless direct liquid fuel cell of claim 1, wherein the oxygen reduction reaction onset potential on the cathode catalyst is from 0.9 V to 1.0 V as measured against a reversible hydrogen electrode.

9. The membraneless direct liquid fuel cell of claim 1, wherein the oxygen reduction reaction peak potential on the cathode catalyst is from 0.85 V to 0.95 V as measured against a reversible hydrogen electrode.

10. The membraneless direct liquid fuel cell claim 1, wherein the open circuit voltage of the membraneless direct liquid fuel cell is from 0.7 V to 1.2 V.

11. The membraneless direct liquid fuel cell of claim 1, wherein the specific power of the membraneless direct liquid fuel cell is from 40 mW cm⁻² to 400 mW cm⁻².

12. The membraneless direct liquid fuel cell of claim 1, wherein the specific current of the membraneless direct liquid fuel cell is from 10 mA cm⁻² to 1000 mA cm⁻².

13. The membraneless direct liquid fuel cell of claim 1, wherein the specific current of membraneless direct liquid fuel cell is from 100 mA to 500 mA per mg of anode catalyst at 0.6 V and 60° C.

14. The membraneless direct liquid fuel cell of claim 1, wherein the loading of the anode catalyst on the anode is from 0.5 mg cm⁻² to 10 mg cm⁻²; the loading of the cathode catalyst on the cathode is from 0.5 mg cm⁻² to 10 mg cm⁻²; or combinations thereof

15. The membraneless direct liquid fuel cell of claim 1, wherein the anode catalyst comprises a precious metal, a non-precious metal, or combinations thereof.

16. The membraneless direct liquid fuel cell of claim 1, wherein the anode catalyst comprises Pd/C, PdCu % C, PdPb/C, PdBi/C, PdSb/C, PtRu/C, PtPb/C, PtBi/C, PtSn/C, Ni, or combinations thereof.

17. The membraneless direct liquid fuel cell of claim 1, wherein the cathode catalyst comprises a noble metal, a metal oxide, a carbon-based catalyst, or combinations thereof.

18. The membraneless direct liquid fuel cell of claim 17, wherein the metal oxide comprises a binary metal oxide, a ternary metal oxide, a quaternary metal oxide, or combinations thereof.

19. The membraneless direct liquid fuel cell of claim 17, wherein the metal oxide comprises a manganese-cobalt oxide, a nickel-cobalt oxide, a manganese-nickel-cobalt oxide, or combinations thereof.

20. The membraneless direct liquid fuel cell of claim 1, wherein the metal oxide comprises MnCo₂O₄, MnNiCoO₄, NiCo₂O₄, or combinations thereof.

21. The membraneless direct liquid fuel cell of claim 1, wherein the cathode catalyst comprises a plurality of particles comprising the metal oxide deposited on a carbon material.

22. The membraneless direct liquid fuel cell of claim 21, wherein the cathode catalyst comprises from 10 to 80 percent by weight of the plurality of metal oxide particles.

23. The membraneless direct liquid fuel cell of claim 21, wherein the carbon material comprises graphene or a plurality of carbon nanotubes.

24. The membraneless direct liquid fuel cell of claim 23, wherein the carbon nanotubes comprise multi-walled carbon nanotubes, nitrogen doped carbon nanotubes, or combinations thereof.

25. The membraneless direct liquid fuel cell of claim 23, wherein the graphene comprises nitrogen doped graphene.

26. The membraneless direct liquid fuel cell of claim 1, wherein the cathode catalyst comprises Pt, MnCo₂O₄/N-MWCNT, MnNiCoO₄/N-MWCNT, NiCo₂O₄/N-graphene, or combinations thereof.
